(19) United States
(12) Patent Application Publication
(10) Pub. No.: US 2009/0051717 A1
(43) Pub. Date: Feb. 26, 2009

(54) Ejection condition adjustment apparatus, droplet ejecting apparatus, and ejection condition adjustment method and program

(75) Inventor: Soichi Kuwahara, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 12/221,420

(22) Filed: Aug. 1, 2008

(30) Foreign Application Priority Data
Aug. 26, 2007 (JP) P2007-219139

(51) Int. Cl. B41J 29/38

(52) U.S. Cl. 347/9

(57) ABSTRACT

An ejection condition adjustment apparatus includes a unit configured to set, in a case where a large head to be driven includes a plurality of small heads each having a number of orifices and the small heads are disposed adjacent to one another on the large head such that regions of the respective small heads where the orifices are provided partially overlap one another, a range of orifices to be used and an ejection timing for the individual small heads such that positional shifts between adjoining ones of patterns formed by the respective small heads are minimized.

### CROSS REFERENCES TO RELATED APPLICATIONS

The present invention contains subject matter related to Japanese Patent Application JP 2007-219139 filed in the Japanese Patent Office on Aug. 26, 2007, the entire contents of which are incorporated herein by reference.

### BACKGROUND OF THE INVENTION

1. Field of the Invention

The present invention relates to techniques for adjusting ejection conditions of a large head including a plurality of small heads each having orifices arranged in order for ejecting ink or other kinds of liquid. According to embodiments of the present invention, an ejection condition adjustment apparatus, a liquid ejecting apparatus, and an ejection condition adjustment method and program are provided.

2. Description of the Related Art

Related art will be described taking several ink jet heads as examples. FIG. 1 is an external view of an exemplary head (hereinafter referred to as a “small head”) 1 in which a number of orifices 3 are arranged in a line.

FIG. 2 is an external view of an exemplary line head (hereinafter referred to as a “large head”) 5 in which a plurality of small heads 1 are disposed along the longitudinal direction of the large head 5 at staggered positions. In the case shown in FIG. 2, the small heads 1 disposed adjacent to one another are staggered by a length of N pixels in a direction orthogonal to a direction in which the orifices are lined.

Other exemplary configurations of the large head 5 are shown in FIGS. 3B and 3C. In one case, a plurality of small heads 1 are arranged stepwise. In another case, the stepwise arrangement is repeated a plurality of times. A configuration shown in FIG. 3A corresponds to the large head 5 shown in FIG. 2.

FIGS. 4 and 5 each show a printing method using a single large head 5 or a plurality of large heads 5. FIG. 4 shows a monochrome printing method, and FIG. 5 shows a multicolor printing method. In each of the printing methods, printing is performed while moving a target recording medium 7 relative to the single large head 5 or the plurality of large heads 5.

When monochrome image data is input to the large head 5 without being processed, referring to FIG. 6, positions of patterns adjacent to one another are staggered in a direction in which the target recording medium 7 is moved, by a length corresponding to a step (N pixels) produced between the adjacent small heads 1. Therefore, it is general to use a method in which addresses for reading monochrome print data and drive timings are staggered by a value corresponding to the length of N pixels. FIG. 7 shows an exemplary case of patterns obtained by such a printing method. As can be seen from FIG. 7, steps between patterns can be eliminated.

On the other hand, if positions of patterns formed by the respective small heads 1 are shifted in a direction perpendicular to a direction in which the target recording medium 7 is moved, gaps (white lines between chips) or overlaps (black lines between chips) may be formed at portions corresponding to boundaries between the small heads 1.

Moreover, if the small heads 1 are mounted with intervals not conforming to the design value, i.e., the length of N pixels, steps such as ones shown in FIG. 8 may be formed between patterns.

In addition, referring to FIG. 5, in a case where printing is performed by using a plurality of large heads 5 arrayed in a direction in which the target recording medium 7 is moved so that images of a plurality of colors are overlaid on top of one another, various positional shifts between patterns of the respective colors are combined together, resulting in compound shifts between patterns of different colors within the printing area of each small head 1.

Furthermore, if the small heads 1 have different printing characteristics, patterns of different densities may be formed for different small heads 1. For example, referring to FIG. 9, clear boundaries can be observed at portions corresponding to boundaries between the small heads 1 because of variations in pattern density.

### SUMMARY OF THE INVENTION

To suppress such phenomena, it is effective to use a method in which positional errors between small heads 1 are reduced as much as possible, that is, a method for assembling small heads 1 with as high an accuracy as possible or a method for selectively using some of small heads 1 having ejection characteristics with little variation. If such a method is assuredly realized, positional shifts at portions corresponding to boundaries can be reduced to as negligible a level as possible.

In current manufacturing techniques, small heads 1 can be assembled within positional errors of about several microns to tens of microns. Positional errors of such an amount only produce negligible steps along a direction in which orifices 3 are lined. However, in terms of the density of a printed image, white lines and black lines, such as ones shown in FIG. 7, may be observed at portions corresponding to boundaries between small heads 1.

To avoid this, referring to FIG. 10, an exemplary method has been proposed in which orifices to be used for forming a pattern corresponding to each boundary between small heads disposed adjacent to one another are gradually and proportionally changed from those of one of the small heads to those of another small head adjacent thereto, whereby irregularities at that portion corresponding to the boundary are reduced to a negligible level. This method is effective as long as a high assembly accuracy is obtained.

Other exemplary methods for reducing irregularities at boundaries to a negligible level will be described below.

Japanese Unexamined Patent Application Publication No. 2002-254649 discloses a technique in which intervals between orifices in one small head become smaller toward an end thereof, and intervals between orifices in another small head become larger toward an end thereof. The small head to be used is changed from the one small head to the another small head at a position where the interval between orifices is approximately equal to a design value. In this technique, occurrence of white lines and black lines at portions corresponding to boundaries between the small heads can be suppressed.

Japanese Unexamined Patent Application Publication No. 2005-1346 discloses a technique in which a head is capable of ejecting droplets in a plurality of directions. In this technique, one pixel is printed with droplets ejected from a plurality of orifices, whereby variations in ejection characteristics among different orifices are evened out and consequently irregularities at portions corresponding to boundaries between small heads are reduced to a negligible level.

Japanese Unexamined Patent Application Publication No. 2005-246861 discloses a technique in which density is corrected only around portions corresponding to boundaries between small heads. For example, if a white line is observed at a portion corresponding to a boundary between two adjacent small heads, only the density at that portion is increased, and if a black line is observed at a portion corresponding to a boundary between two adjacent small heads, only the density at that portion is reduced. Thus, occurrence of white and black lines are suppressed to a negligible level.

In any of the above-described techniques, however, their intended effects can be produced only when errors in landing positions among different small heads fall within the range of several microns to tens of microns. That is, it is desired to improve accuracies of a small-head assembling apparatus and other components. In that case, small heads having positional errors exceeding a tolerable range are all regarded as defective (NG) products. This leads to a poor yield and a very high production cost.

Moreover, the longer the printable area width of a large head, the larger the number of small heads. That is, as the length of large heads increases, the yield of large heads decreases and the production cost increases.

To avoid this by reducing the number of small heads included in a large head, that is, by increasing the number of orifices included in each small head, the yield of small heads decreases instead and the production cost increases, naturally.

In light of the above, the present inventor proposes a technique in which a signal processing technique is used to relax desired accuracies of small heads and large heads.

According to an embodiment of the present invention, an ejection condition adjustment apparatus includes a unit configured to set, in a case where a large head to be driven includes a plurality of small heads each having a number of orifices and the small heads are disposed adjacent to one another on the large head such that regions of the respective small heads where the orifices are provided partially overlap one another, a range of orifices to be used and an ejection timing for the individual small heads such that positional shifts between adjoining ones of patterns formed by the respective small heads are minimized.

In the technique proposed by the present inventor, even if manufacturing accuracies of small heads and large heads are lower than those in the related art, positional shifts and irregularities at boundaries between patterns formed by the respective small heads can be reduced to a negligible level.

Thus, it becomes possible to improve the yield and reduce the manufacturing cost for not only small heads of short length but also large heads of long length.

### BRIEF DESCRIPTION OF THE DRAWINGS

FIG. 1 is an external view of an exemplary small head;

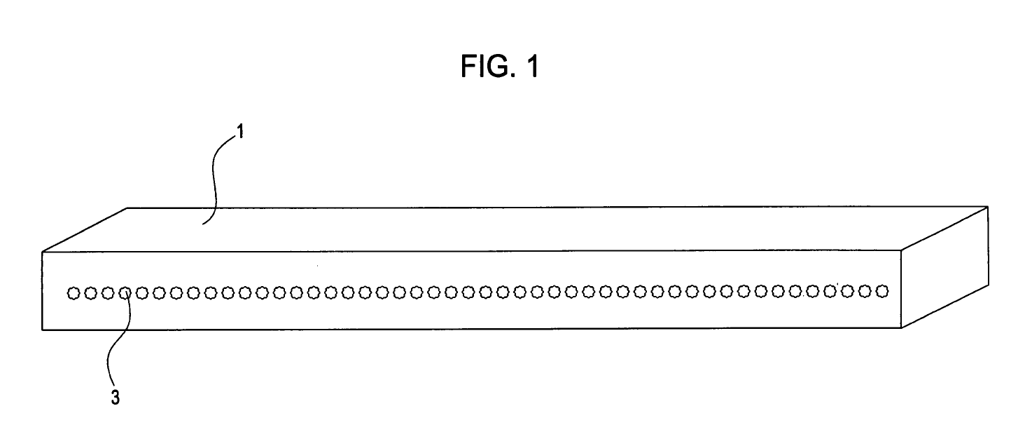

FIG. 2 is an external view of an exemplary large head;

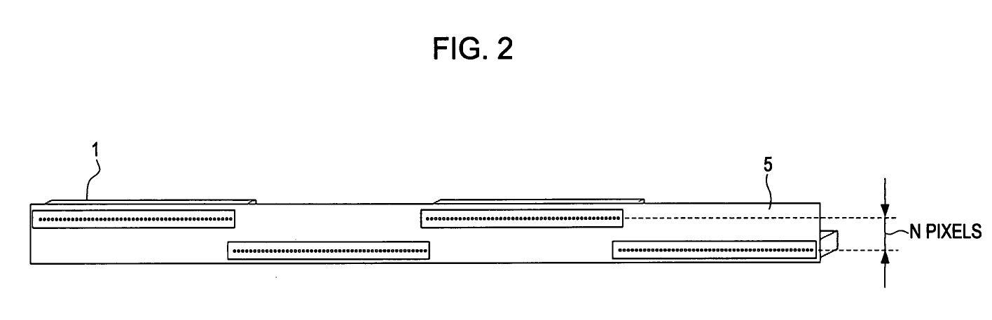

FIGS. 3A, 3B, and 3C are external views of exemplary large heads;

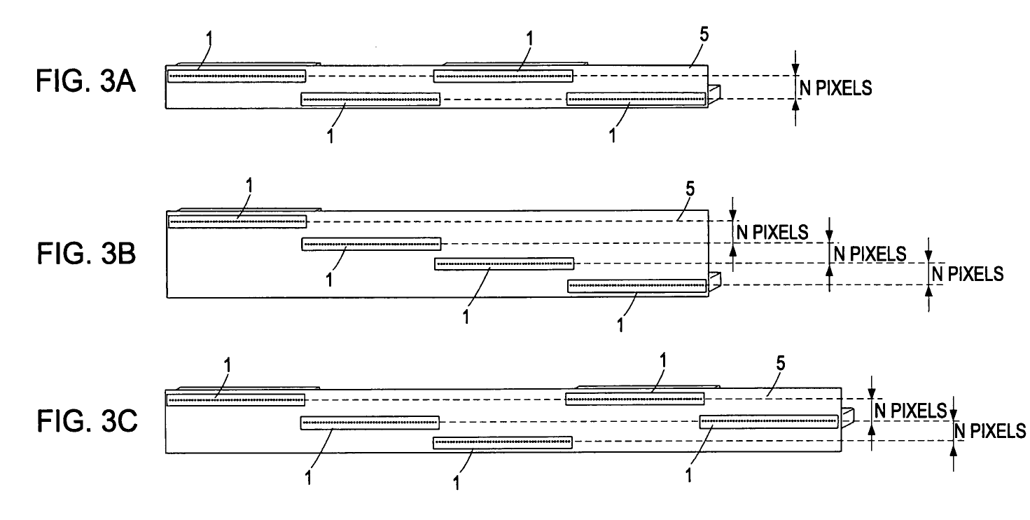

FIG. 4 shows a printing technique using a large head;

FIG. 5 shows a printing technique using large heads;

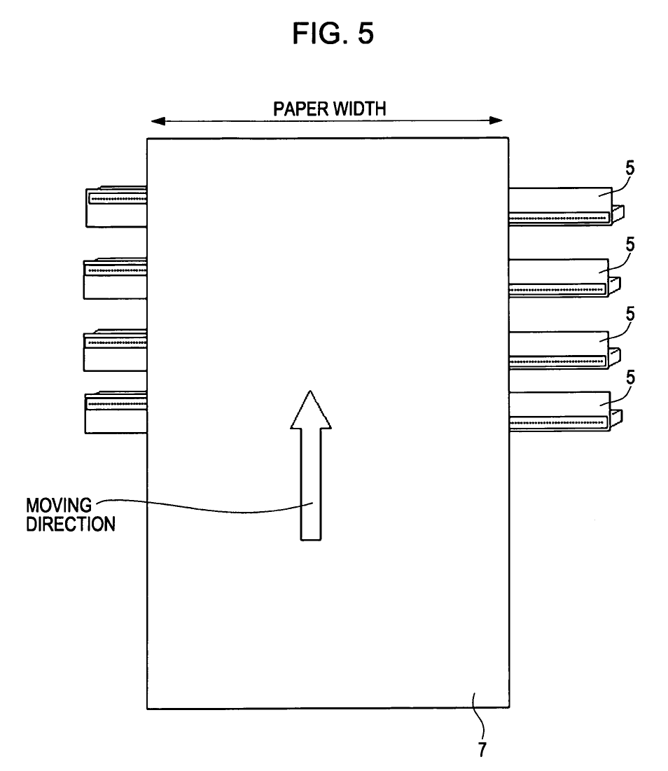

FIG. 6 shows an exemplary print result obtained without timing adjustment;

FIG. 7 shows an exemplary print result obtained with timing adjustment;

FIG. 8 shows an exemplary print result in a case where there are positional errors in assembly;

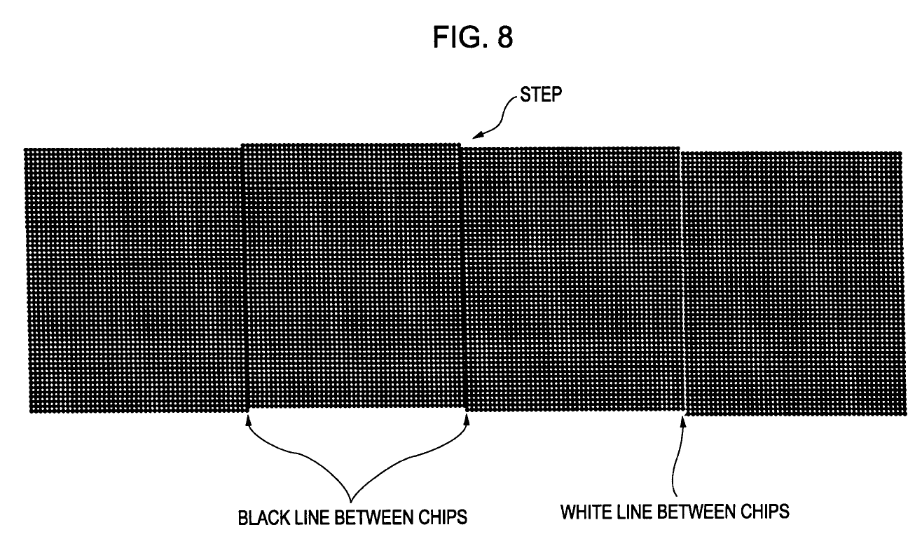

FIG. 9 shows an exemplary print result in a case where there are variations in density among small heads;

FIG. 10 shows an exemplary related-art printing technique for suppressing irregularities at portions corresponding to boundaries between small heads;

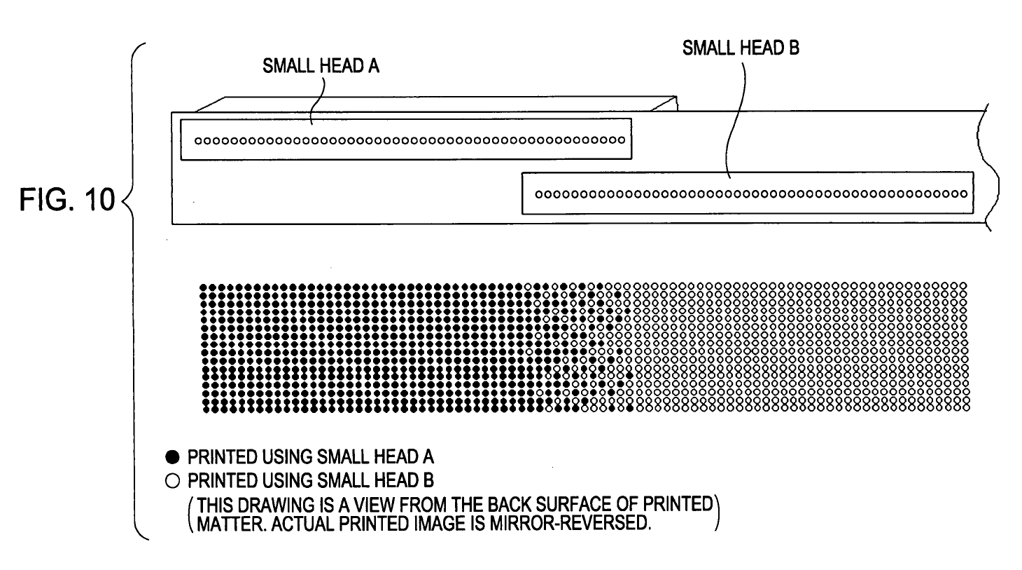

FIG. 11 is an external view of an exemplary large head;

FIGS. 12A, 12B, and 12C each show the relationship between errors in positions of small heads and deterioration in pattern quality;

FIGS. 13A, 13B, and 13C show exemplary adjustment methods;

FIGS. 14A and 14B show cases where there are errors in mounting positions of small heads in a sub-scanning direction;

FIG. 15 shows an exemplary configuration of a typical print processor;

FIG. 16 shows an ideal density characteristic;

FIG. 17 shows an actual density characteristic;

FIG. 18 shows an exemplary configuration of a print processor having a density correction function;

FIG. 19 shows an exemplary tone-correction curve;

FIG. 20 shows a print result in a case where there is an overlap between pixel rows;

FIG. 21 shows a print result in a case where there is a gap between pixel rows;

FIG. 22 shows the relationships between input signals and pixel densities corresponding to the case shown in FIG. 20;

FIG. 23 shows the relationships between input signals and pixel densities corresponding to the case shown in FIG. 21;

FIG. 24 shows an exemplary configuration of a print processor having a correction information storing unit;

FIG. 25 shows another exemplary configuration of a print processor having a correction information storing unit;

FIG. 26 shows an exemplary configuration of a print head including a plurality of large heads;

FIG. 27 shows an exemplary adjustment method in a case where a plurality of large heads are provided for different ink colors;

FIG. 28 shows a case where small heads are mounted with tilts with respect to the longitudinal direction of a large head;

FIGS. 29A, 29B, and 29C each show an exemplary adjustment method in the case where small heads are mounted with tilts;

FIGS. 30A, 30B, 30C, and 30D each show the relationship between a print head including two large heads on which small heads are mounted with tilts and the print result thereof;

FIGS. 31A and 31B show technique for adjusting ranges of orifices to be used for printing;

FIG. 32 shows a method for varying positions of boundaries between the ranges of orifices to be used for printing provided in respective small heads among large heads provided for different colors;

FIG. 33 shows an exemplary case where the range of orifices to be used for printing provided in one small head may overlap at ends thereof with the ranges of orifices to be used for printing provided in small heads adjacent thereto.

FIG. 34 shows a print result in a case where ejection directions conform to design values;

FIG. 35 shows a print result in a case where ejection directions vary;

FIG. 36 shows a technique of deflected ejection;

FIG. 37 shows an advantage produced by applying the technique of deflected ejection;

FIG. 38 shows an advantage in a case where ejection can be deflected in many directions;

FIG. 39 shows the concept of a pulse number modulation (PNM) method;

FIG. 40 shows the concept of a method in which the maximum PNM value is set to 4 and ink droplets are ejected sequentially from three different orifices;

FIG. 41 shows a case where a single pixel row is formed by sequentially changing the orifice to be used;

FIG. 42 shows a case where each pixel row facing the boundary between small heads are printed by deflected ejection using a single small head;

FIG. 43 shows the case where each pixel row facing the boundary between small heads are printed by deflected ejection using a single small head;

FIG. 44 shows a case where each pixel row facing the boundary between small heads are printed by deflected ejection using different small heads;

FIG. 45 shows the case where each pixel row facing the boundary between small heads are printed by deflected ejection using different small heads;

FIG. 46 shows a case where each pair of pixel rows facing the boundary between small heads are printed by deflected ejection using different small heads;

FIG. 47 shows an exemplary configuration of a small head capable of simultaneously printing in a plurality of colors;

FIG. 48 shows an exemplary large head including a plurality of small heads capable of simultaneously printing in a plurality of colors;

FIG. 49 shows an exemplary printing system;

FIG. 50 shows an exemplary configuration of an ink jet printer; and

FIG. 51 shows another exemplary printing system.

### DESCRIPTION OF THE PREFERRED EMBODIMENTS

Embodiments of the present invention will now be described taking an ink jet large head including a plurality of small heads as an example.

Elements that are not provided with particular drawings or descriptions herein are realized by existing techniques in the relevant technical field.

Embodiments described below are only exemplary, and the present invention is not limited thereto.

### (A) Ejection Condition Adjustment Method

### (A-1) Adjustment Method Suitable for Monochrome Ink Jet Head

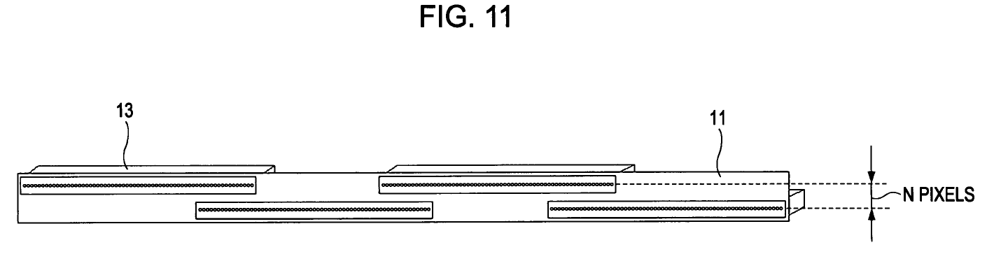

A case of a large head used for monochrome printing will be described. FIG. 11 shows an exemplary configuration of a large head 11 for monochrome printing. As shown in FIG. 11, the large head 11 is provided with small heads 13 along the longitudinal direction at staggered positions. The small heads 13 each have a line of a number of orifices 3 (dots shown on the small heads 13).

### (a) Exemplary Adjustment Method 1

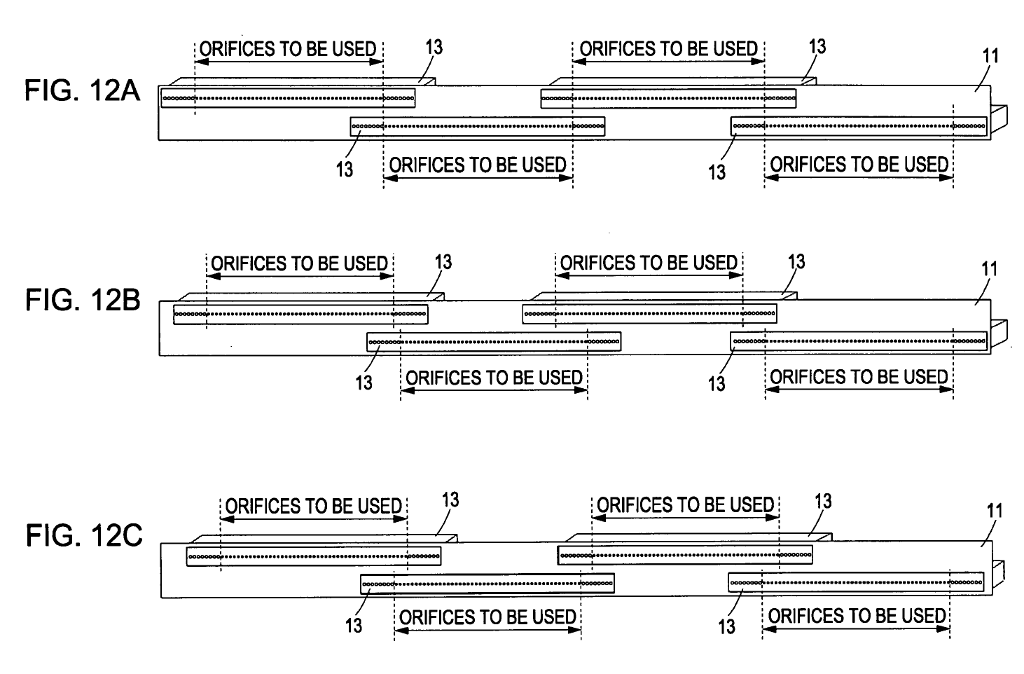

FIGS. 12A to 12C show reasons why positional shifts of patterns occur at portions corresponding to boundaries between small heads 13 disposed adjacent to one another. FIG. 12A shows the relationship between the small heads 13 and their respective ranges of orifices to be used for printing in a case where the small heads 13 whose orifices of a fixed range are to be used for printing are mounted with no errors in a direction of the line of the orifices.

In the case shown in FIG. 12A, there are no overlaps nor gaps between the ranges of orifices to be used for printing.

Practically, however, because of variations in assembly and the like, positional errors between the small heads 13 in a direction of the line of the orifices frequently occur. Referring to FIGS. 12B and 12C, it can be seen that there are overlaps and gaps between the ranges of orifices to be used for printing provided in adjacent small heads 13.

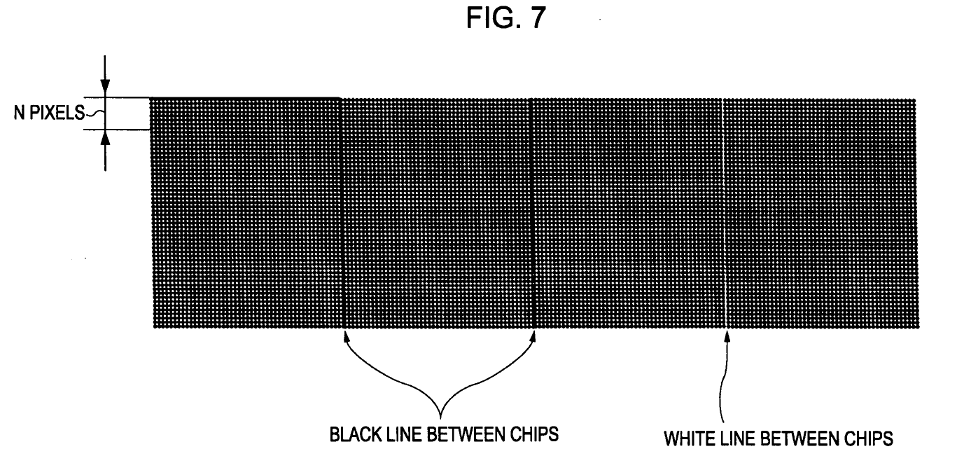

In the related art, if printing is performed in such a state, white lines and black lines described above referring to FIG. 7 tend to appear. Such a large head is not suitable for practical use.

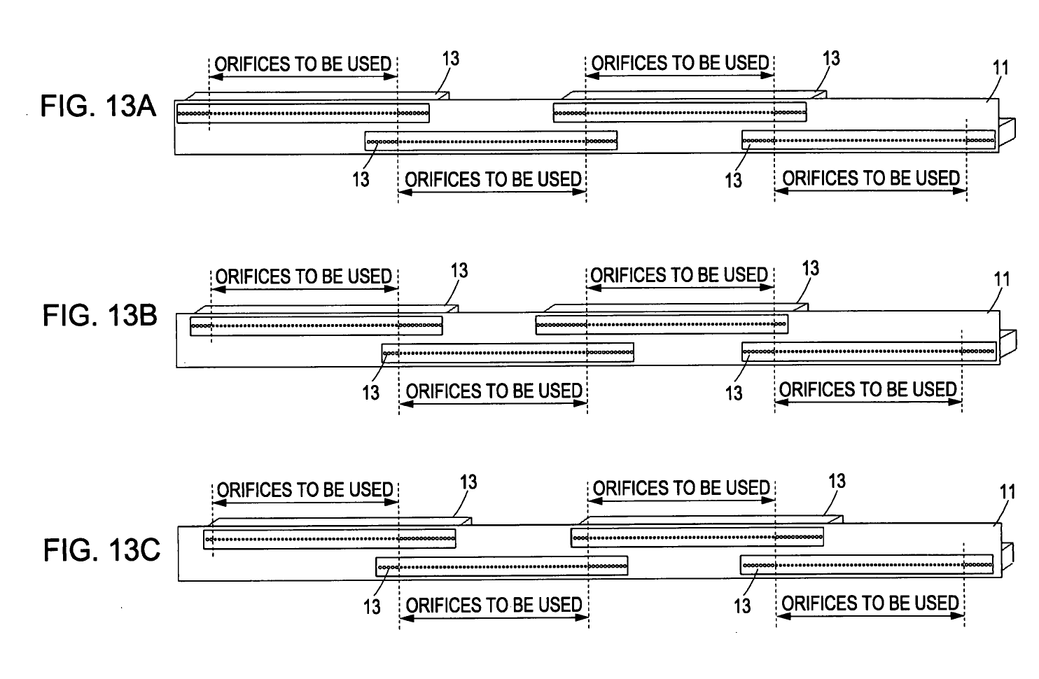

FIGS. 13A to 13C each show the relationship between the small heads 13 and their respective ranges of orifices to be used for printing in a case where a technique proposed by the present inventor is applied. It should be understood that the small heads 13 in FIGS. 13A to 13C are mounted in the same manner as those in FIGS. 12A to 12C.

As can be seen from FIGS. 13B and 13C, by staggering the ranges of orifices to be used (dots shown in black) in the respective small heads 13, occurrence of gaps and overlaps at boundaries between patterns formed by the small heads 13 adjacent to one another can be prevented.

The amounts of errors in mounting positions of the respective small heads 13 are referred to in setting the range (position and width) of orifices to be used for printing. These amounts of errors may be directly measured with the small heads 13 mounted on the large head 11. Alternatively, after a test pattern is printed using the large head 11, positional shifts in the test pattern may be read. In many cases, positions of patterns on a printed matter are not in complete conformity with positions of the orifices. Therefore, a higher accuracy can be expected by reading the print result.

### (b) Exemplary Adjustment Method 2

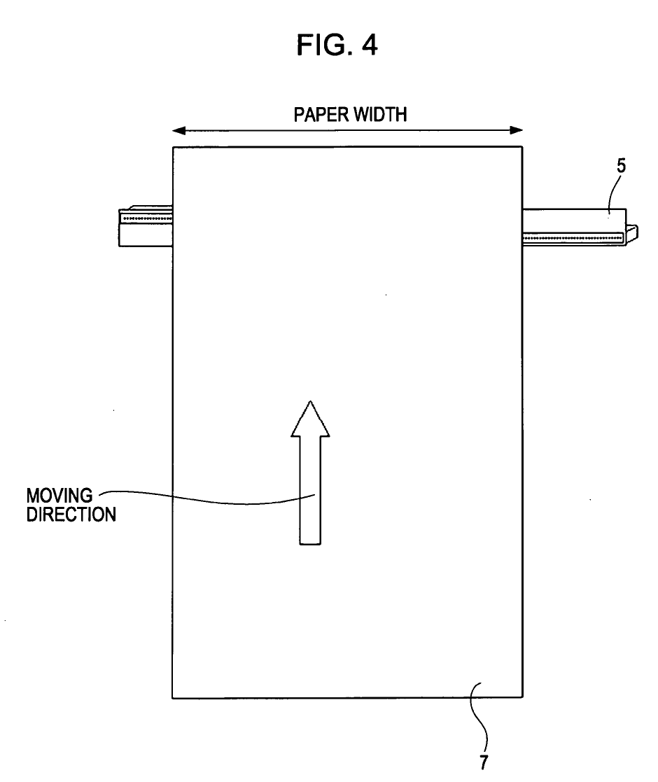

Another adjustment method will be described. In this method, errors in mounting positions of the small heads 13 occur in a direction in which the target recording medium 7 moves relative to the head, including the small heads 13 and the large head 11 (hereinafter referred to as a sub-scanning direction), as described above referring to FIG. 4. Needless to say, the ink jet head is the large head 11 shown in FIG. 11, in which a plurality of small heads 13 are disposed along the longitudinal direction at staggered positions.

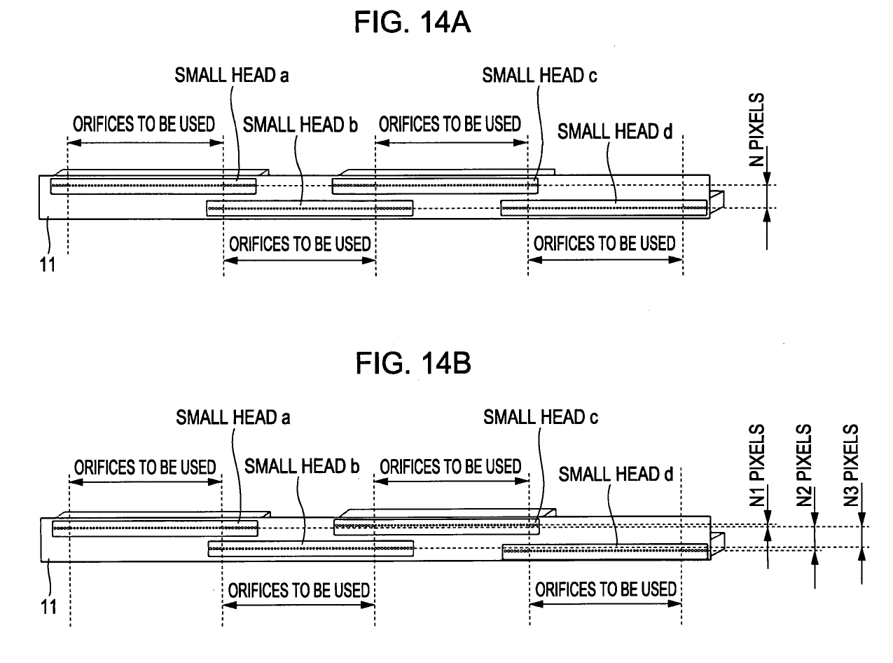

FIGS. 14A and 14B each show an exemplary configuration of the large head 11 in which errors in mounting positions of the small heads 13 occur in the sub-scanning direction. FIG. 14A shows a case of ideal mounting positions. That is, small heads a and c are disposed at the same positions in the sub-scanning direction and the orifices of small heads b and d are spaced apart from the orifices of the small heads a and c by a length of N pixels.

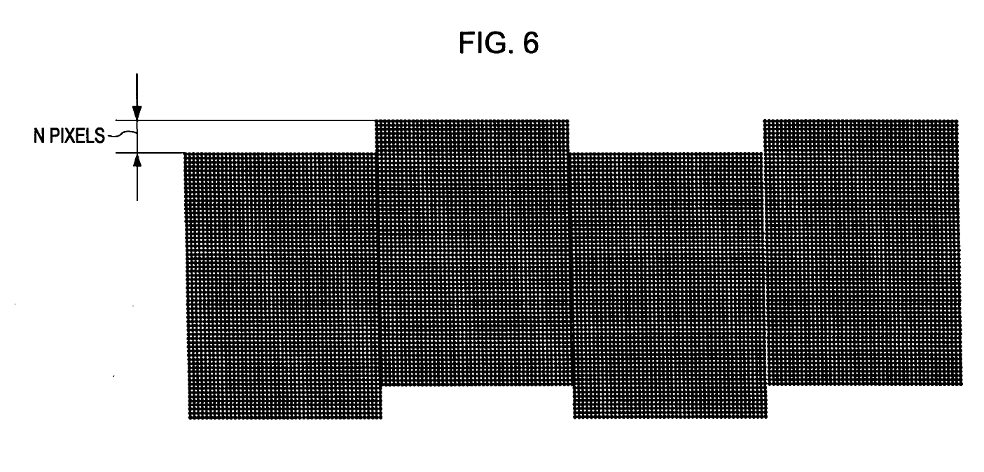

Let us assume that printing is performed by using the large head 11 assembled with the small heads 13 ideally mounted thereon and by moving the target recording medium 7 relative to the large head 11 as shown in FIG. 4. In the case of monochrome printing, if image data is used for printing without being processed, patterns formed by different small heads 13 are shifted by a length of N pixels in a direction in which the target recording medium 7 is moved, as shown in FIG. 6.

To avoid this, print-data read addresses and head drive timings are staggered in conformity with the length of N pixels, whereby the head is driven in such a manner as to realize a stepless print result such as the one shown in FIG. 7.

However, mounting positions of the small heads a, b, c, and d may be shifted from the original design values as shown in FIG. 14B (in FIG. 14B, there are positional shifts of three lengths: N1 pixels, N2 pixels, and N3 pixels). In such a case, even if print-data read addresses and head drive timings are staggered in conformity with the length of N pixels, differences between the N pixels and the N1, N2, and N3 pixels lead to steps in the print result.

In view of the above, the present inventor proposes a method in which print-data read addresses and print timings are optimized by calculating the amounts of shifts of the respective small heads 13 with respect to the position of a reference small head 13 defined in the sub-scanning direction, considering errors in droplet landing positions due to mounting errors and the like.

To summarize, a print result with no steps at boundaries between patterns formed by adjacent small heads can be realized, not by defining a single fixed positional shift with an assumption that components are assembled ideally or with tolerable errors, but by calculating actual positional shifts of the respective small heads and utilizing the calculated results in adjusting ejection conditions.

Needless to say, errors in mounting positions in the sub-scanning direction may be directly measured with the small heads 13 mounted on the large head 11. Alternatively, after a test pattern is printed using the large head 11, positional shifts in the test pattern may be read. In many cases, positions of patterns on a printed matter are not in complete conformity with positions of the orifices. Therefore, a higher accuracy can be expected by reading the print result.

### (c) Exemplary Adjustment Method 3

When the foregoing two adjustment methods are combined, errors in mounting positions of the small heads occurring in either or both of the sub-scanning direction and the direction of the line of orifices can be corrected. Thus, print quality can be improved.

Now, in this exemplary method, density correction for the individual small heads is also incorporated, whereby irregularities at portions corresponding to boundaries between the small heads are to be suppressed to a negligible level.

Needless to say, density correction is performed by correcting values of print data on the volume of ink droplets to be ejected, the pixel size to be formed by ejected ink droplets, and so forth.

In this case, density correction may be performed in units of any of the following: portions corresponding to boundaries between the small heads 13, the entirety of the large head, each pixel row, or each orifice.

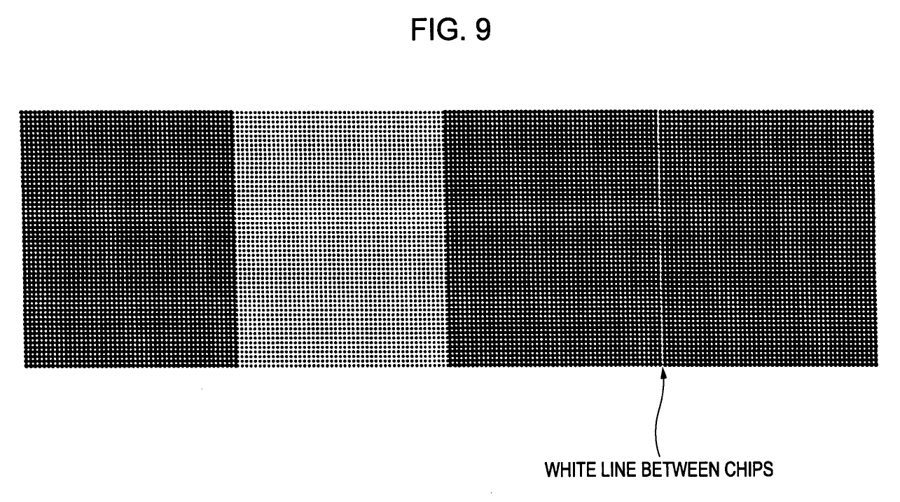

Which of the foregoing units is used for density correction varies depending on the cause of deterioration in the quality of the print result. For example, to eliminate fine lines remaining even if errors between the small heads are minimized, only correction for portions corresponding to boundaries between the small heads is sufficient, usually. In some actual cases, however, differences in density between images formed by the small heads, such as the ones shown in FIG. 9, are also problematic. Therefore, it is desirable to perform correction for each pixel row, because defects in portions other than defects at portions corresponding to the boundaries can also be corrected.

Now, a density correction method will be described. There are several density correction methods. Herein, two of them will be described. The methods described herein can be applied to other exemplary adjustment methods.

In a first correction method, input data is corrected for each pixel row printed by the corresponding orifice, in accordance with a tone characteristic of that pixel row.

In the first correction method, tone correction data is prepared for each pixel row. In accordance with the tone correction data, input data is corrected.

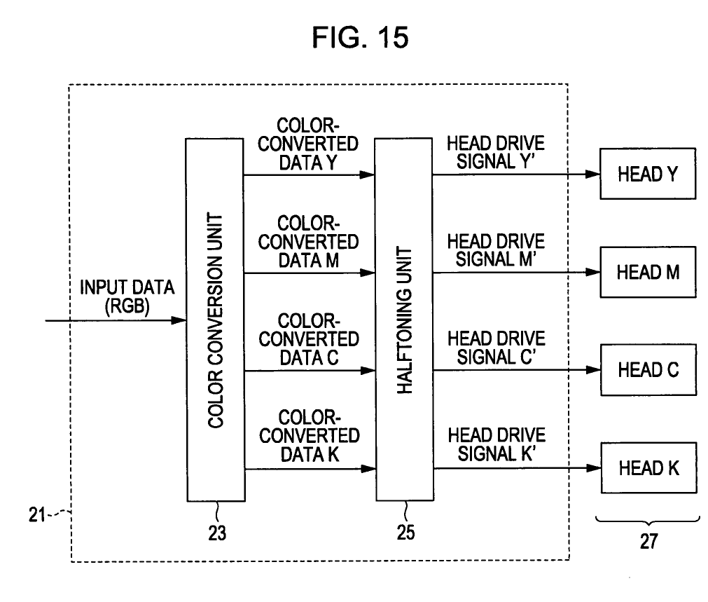

FIG. 15 shows an exemplary configuration of a typical print processor 21. The print processor 21 serves as hardware such as an integrated circuit or a processor that processes a program executed on a central processing unit (CPU).

The print processor 21 receives input data such as digital data of RGB format. In FIG. 15, the length of input data for each color is 8 bits. Hence, digital data for each color contains information of 256 tones ranging from 0 to 255. The total length of digital data for all the three colors is 24 bits.

A color conversion unit 23 converts the input data into data of four ink colors (8-bit data representing 0 to 255 for each color). The four ink colors are yellow (Y), magenta (M), cyan (C), and black (K).

A halftoning unit 25 converts the color-converted data into drive data for print heads 27 provided in correspondence with the four colors.

The print heads 27, which correspond to the large heads 11, each eject ink droplets in accordance with the drive data, thereby forming a print image on a target print medium.

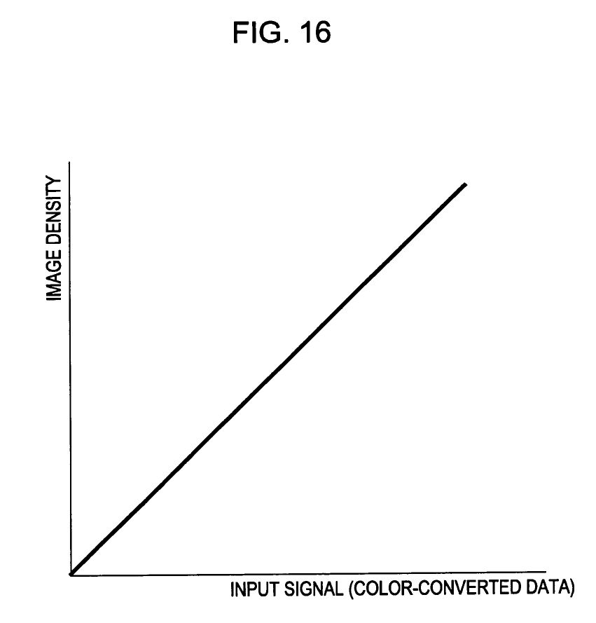

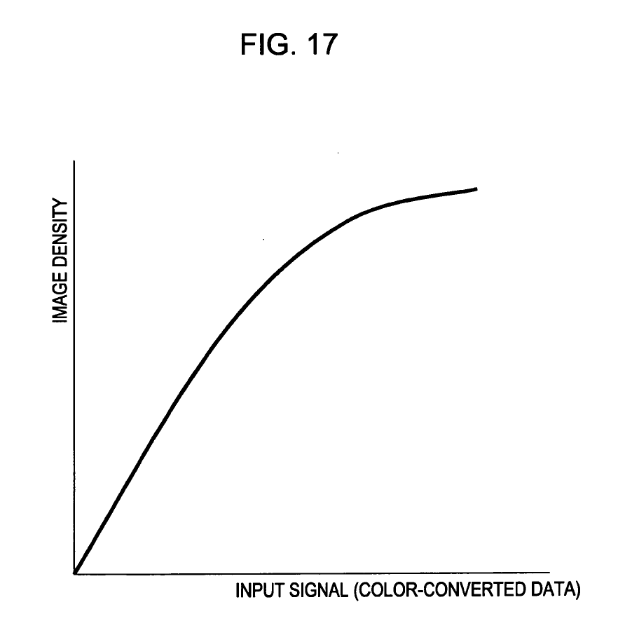

It is desirable that the density of each color observed in the output result have an ideal relationship with respect to the color-converted data values of 0 to 255 output from the color conversion unit 23 (such as the one shown in FIG. 16). Practically, however, such an ideal relationship is unusual. A relationship shown in FIG. 17 is a typical example.

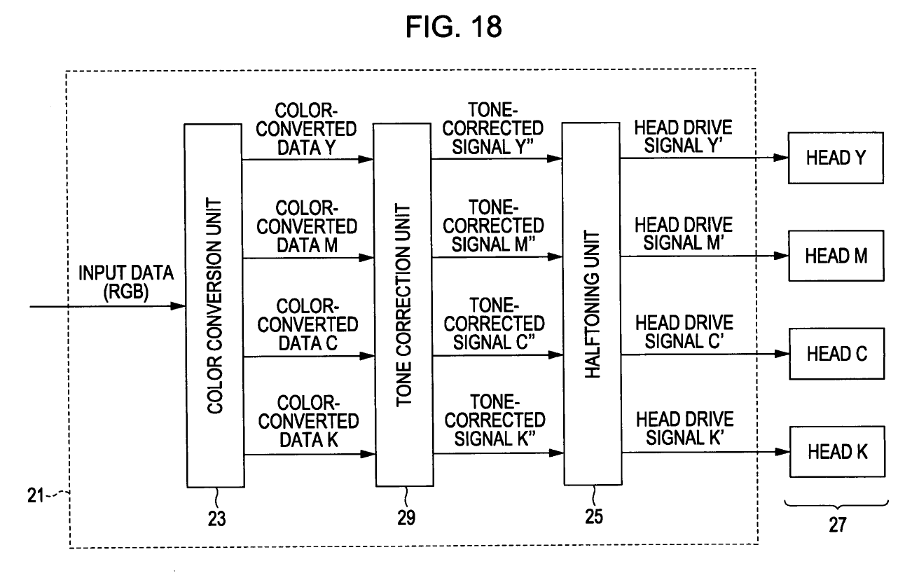

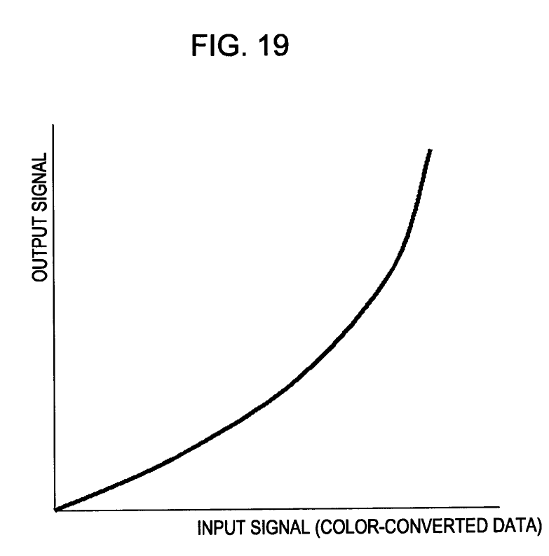

Therefore, in general, a print processor 21 shown in FIG. 18 is used for correcting output results of the respective colors so as to obtain ideal values. Specifically, a tone correction unit 29 having a tone correction curve shown in FIG. 19 is provided on the subsequent stage of the color conversion unit 23 so as to correct the tone characteristic (shown in FIG. 17) of an input signal (color-converted data), whereby an output result is made to coincide with the line shown in FIG. 16.

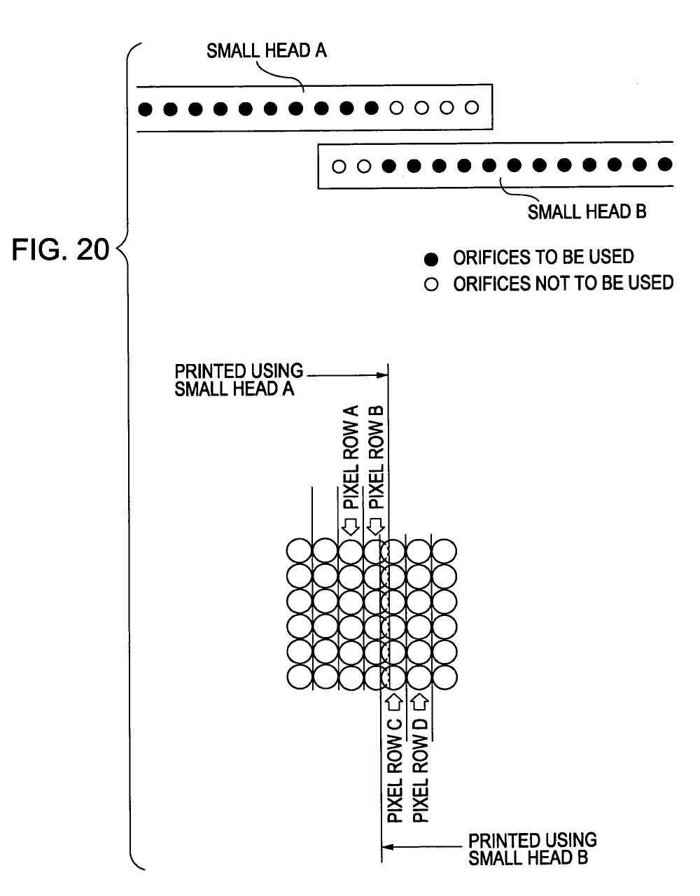

Let us consider a print result at a portion corresponding to the boundary between two small heads. Referring to FIG. 20, when the ranges of orifices to be used slightly overlap each other between the two small heads, the densities of pixel rows B and C become higher than the densities of pixel rows A and D.

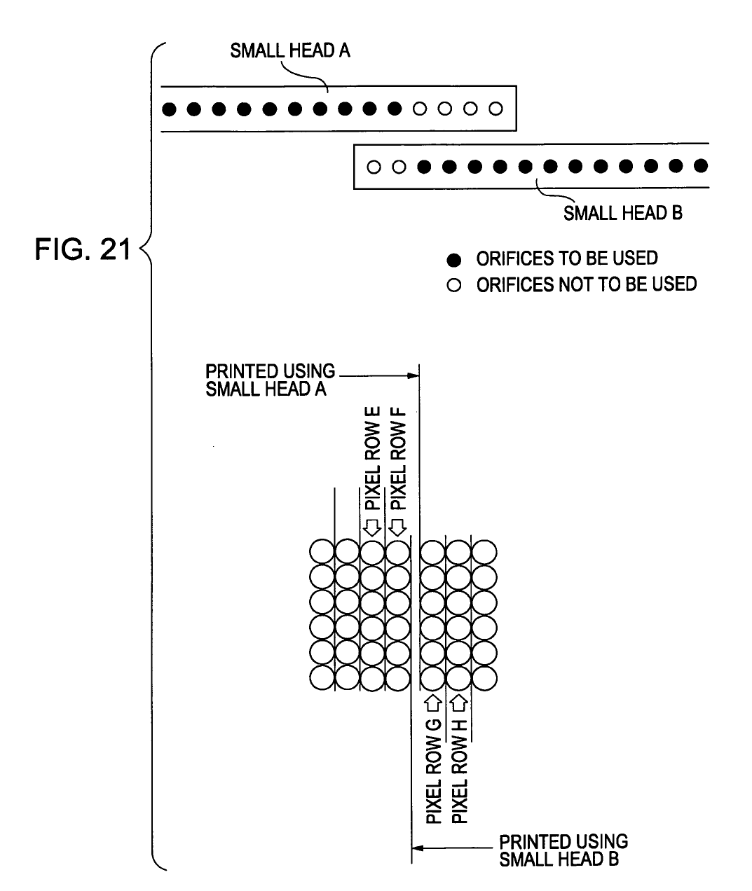

Referring now to FIG. 21, when there is a small gap at a portion corresponding to the boundary between the two small heads, the densities of pixel rows F and G become lower than the densities of pixel rows E and H.

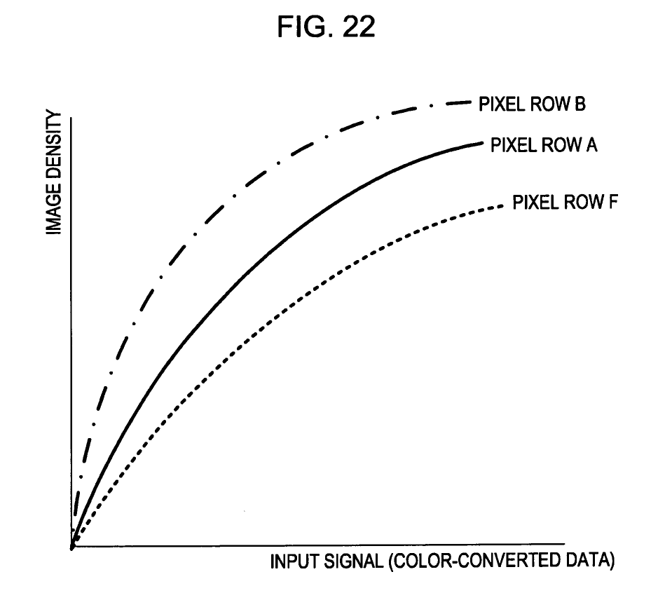

Consequently, the relationship between the density and the input signal for each of the pixel rows is expressed as shown in FIG. 22.

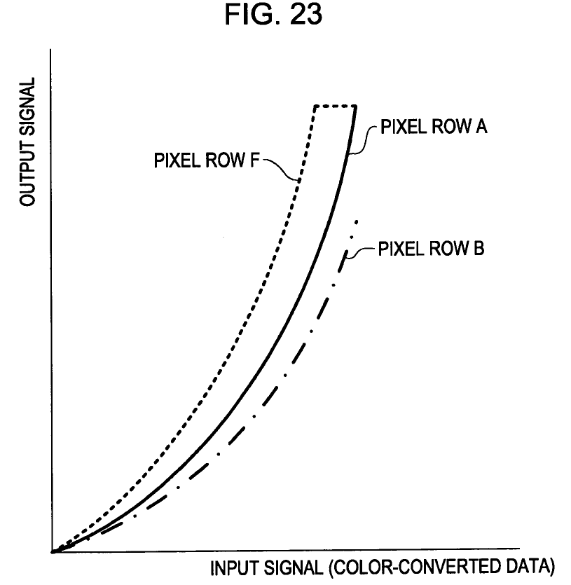

Hence, tone-characteristic correction curves shown in FIG. 23 are provided for the respective pixel rows so as to correct the input signals (color-converted data) for the respective pixel rows, whereby output characteristics are made to conform with the ideal values (such as the relationship shown in FIG. 16).

In this manner, variations in density in the printed matter can be eliminated or reduced. In FIG. 23, it is difficult to realize a desired density for the pixel row F where density should be increased. Therefore, the output data of the color-converted data after a certain point stays at the upper limit.

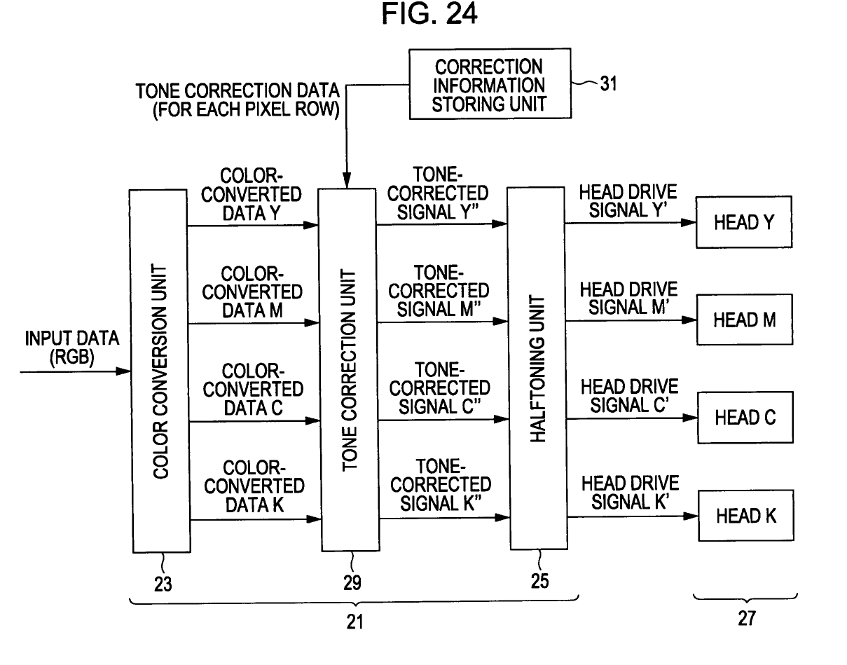

The tone correction data for each pixel row is generated beforehand by scanning the print result of a test pattern, for example, and the scanned data is stored in a correction information storing unit 31 shown in FIG. 24. When printing is performed, the tone correction unit 29 converts data in accordance with the tone correction data that differs among pixel rows.

It is ideal that the tone correction data be provided for each pixel row. Alternatively, several kinds of typical curves may be prepared beforehand so that a suitable one can be selected therefrom.

Next, a second correction method will be described. The second correction method is effective for printing apparatuses capable of density modulation of several levels per pixel.

Herein, a printing apparatus capable of density modulation of 5 levels per pixel is taken as an example.

In an exemplary method of density modulation, the number of droplets that form one pixel is changed. Specifically, the density in one pixel is modulated by performing printing in accordance with a rule such as the following: Level 0 means no ejection, Level 1 means ejection of one droplet, Level 2 means ejection of two droplets, Level 3 means ejection of three droplets, and Level 4 means ejection of four droplets.

In another exemplary method of density modulation, the volume of a droplet that forms one pixel is changed. Specifically, Level 0 means no ejection, Level 1 means ejection of a droplet of the smallest volume, Level 2 means ejection of a droplet of the second smallest volume, Level 3 means ejection of a droplet of the third smallest volume, and Level 4 means ejection of a droplet of the largest volume.

A case where the output data of a certain pixel row is 3, 3, 3, 3, 3, 3, 3, 3, 3, 3 will be considered. In this case, when the head is driven without density modulation, densities of the pixel rows B and C shown in FIG. 20 are high, while densities of the pixel rows F and G shown in FIG. 21 are low, as described above.

Therefore, it is desired to lower the correction level for the output data of the pixel rows B and C and to heighten the correction level for the output data of the pixel rows F and G.

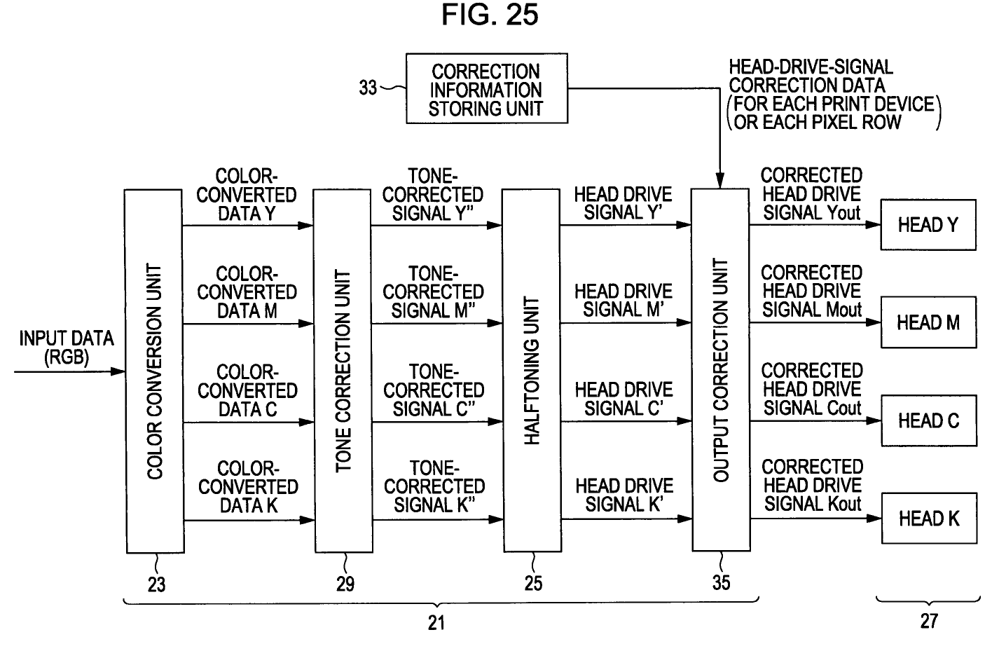

To realize this, desired correction levels for the respective pixel rows are stored as correction information in a correction information storing unit 33 shown in FIG. 25.

In FIG. 25, an output correction unit 35 corrects head drive signals Y′, M′, C′, and K′ in accordance with the correction information and outputs corrected head drive signals Yout, Mout, Cout, and Kout. Through this correction, differences in density among pixel rows are eliminated or reduced.

Specific processing of this correction will be described. When correction information on a certain pixel row is 1.2 (where a case of no correction is defined as 1), the corresponding head drive signal is tentatively converted by using the following function: tentative output value=f(pre-correction output value, correction information).

For example, when f(pre-correction output value, correction information)=pre-correction output value×correction information, the tentative output values are 3.6, 3.6, 3.6, 3.6, 3.6, 3.6, 3.6, 3.6, 3.6, 3.6. Suppose that actual output can only take integers. In such a case, for example, 3.5 is taken as a threshold. Since the first data value 3.6 is larger than 3.5, the first data value is converted into “4”.

In calculating a subsequent data value, the sum of the subsequent data value and the difference between the immediately preceding data value and the subsequent data value (in this case, 3.6 −4=−0.4) is compared with the threshold. That is, 3.2 (=3.6+(−0.4)) and 3.5 are compared. Thus, the output data of “3” is obtained.

This processing in which the difference, i.e., the error, used for determining output data is sequentially carried over to determination of the subsequent output data is repeated. In other words, conversion into integers is performed by an error diffusion method.

In this example, the string of the head drive signals is converted into 4, 3, 4, 3, 4, 4, 3, 4, 3, 4.

By such a correction method, densities of pixel rows can be increased. In this example, the error is fully carried over to the subsequent data. It is also allowable that ⅔ of the error is carried over to the immediately subsequent data and ⅓ of the error is carried over to the next most subsequent data. That is, weighted error diffusion may be employed.

In this example, since the error is diffused in a direction of each pixel row, there is no correlation with pixel rows adjacent thereto. Therefore, density may change in an almost constant cycle, leading to variations in density. To prevent this, the initial error may be defined by random numbers or a mechanism for determining correction values considering the correction result in an adjacent pixel row may be incorporated.

### (d) Exemplary Adjustment Method 4

The foregoing examples concern an ink jet head including a single large head.

Naturally, the adjustment method can also be applied to a case where an ink jet head includes a plurality of large heads aligned in the longitudinal direction of the ink jet head, that is, a case where a single print head includes two or more large heads 11 disposed thereon along the direction of the line of orifices at staggered positions.

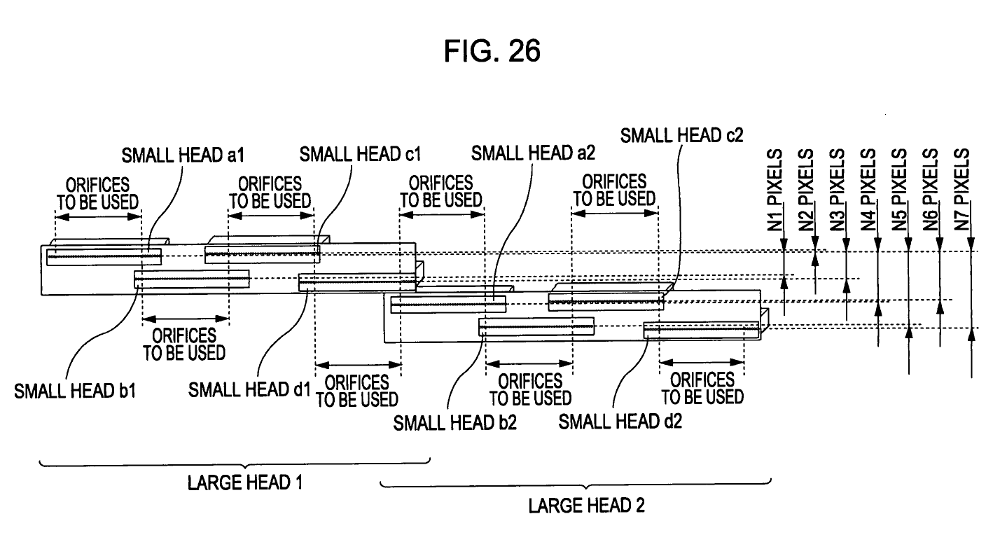

FIG. 26 shows an example of such a print head. In the example shown in FIG. 26, two large heads each including a plurality of small heads are aligned.

In this example, regardless of differences between the large heads, the range of orifices to be used for printing is set for the individual small heads disposed adjacent to one another, whereby gaps and overlaps at portions corresponding to boundaries between the small heads are reduced as much as possible. Further, by changing the print-data read address and the print timing for each of the small heads, steps at portions corresponding to boundaries between the small heads are made smaller. In addition, density is corrected for each small head so that irregularities at boundaries between patterns formed by small heads adjacent to one another are suppressed to a negligible level.

### (A-2) Adjustment Method Suitable for Multicolor Ink Jet Head

The foregoing description concerns ejection condition adjustment methods that suppress deterioration in print quality caused by errors in mounting positions of small heads, with the proviso that monochrome printing is performed by using a single large head or a plurality of large heads.

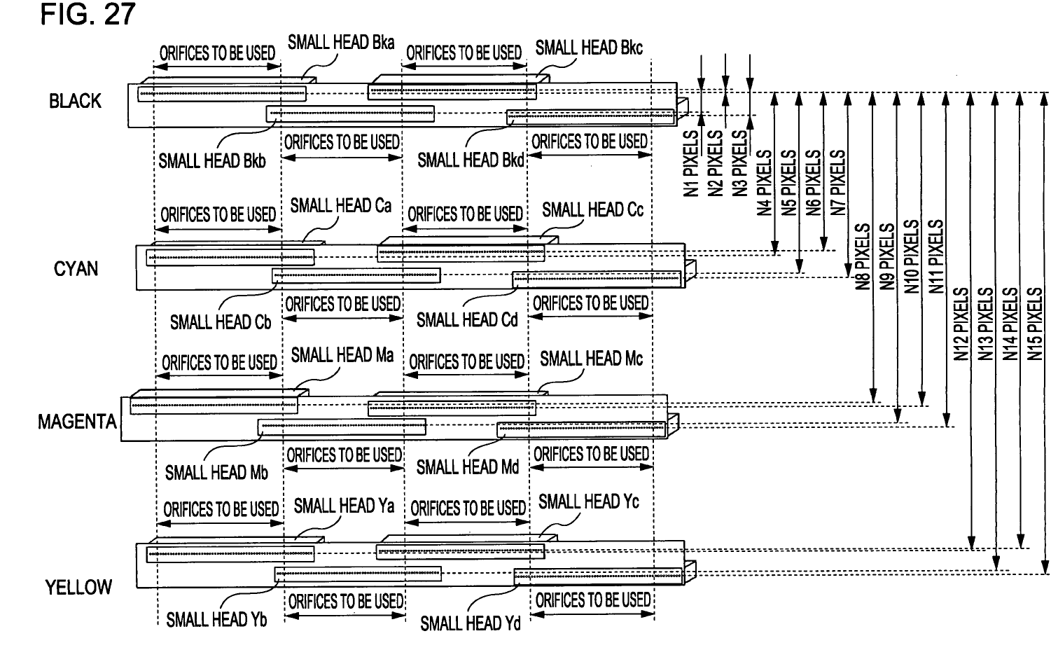

In this example, as shown in FIG. 27, an adjustment method in a case where an ink jet head includes large heads for printing in different ink colors (including ink of the same color but different densities) will be described. FIG. 27 shows a case of four ink colors of black, cyan, magenta, and yellow. In addition, four large heads are spaced apart from each other with offsets therebetween specified in the sub-scanning direction.

In this case, not only errors in mounting positions between small heads included in each of the large heads but also errors in mounting positions between small heads included in different large heads at the corresponding longitudinal-direction positions are considered. In each large head, errors in mounting positions may be canceled out by signal processing. However, unless errors in droplet landing positions between the large heads for printing in different colors are corrected, shifts between different color patterns (hereinafter referred to as color shifts) and accompanying line-type irregularities at portions corresponding to boundaries may occur.

FIG. 27 shows the principle of an adjustment method that is proposed considering such shifts. To avoid complexity, FIG. 27 is illustrated provided that there are errors in mounting positions of the small heads in the sub-scanning direction. Accordingly, with one of the small heads being as a reference, the amounts of shifts with respect to the reference small head are defined for the number of all the small heads minus one.

To summarize, the adjustment methods described above for ink jet heads for monochrome printing can also be applied to ink jet heads for multicolor printing in which a plurality of the large heads 11 are arrayed in the sub-scanning direction.

Thus, also in ink jet heads for multicolor printing, steps, gaps, and overlaps at boundaries between patterns and color shifts can be minimized by optimizing the print-data read address and the print timing for the individual small heads. Needless to say, by incorporating density correction, irregularities at portions corresponding to boundaries between small heads and color shifts can be reduced to a negligible level.

Also in this case, errors in mounting positions in the direction of the line of orifices and in the sub-scanning direction may be directly measured with the small heads 13 mounted on the large head 11. Alternatively, after a test pattern is printed using the large head 11, positional shifts in the test pattern may be read. In many cases, positions of patterns on a printed matter are not in complete conformity with positions of the orifices. Therefore, a higher accuracy can be expected by reading the print result.

### (A-3) Adjustment Method When Small Heads are Tilted With Respect to Ink-Jet-Head Longitudinal Direction

The foregoing description concerns adjustment methods in the case where lines of orifices in different small heads are parallel to each other, although mounting positions of small heads are shifted in at least one of the ink-jet-head longitudinal direction and the sub-scanning direction.

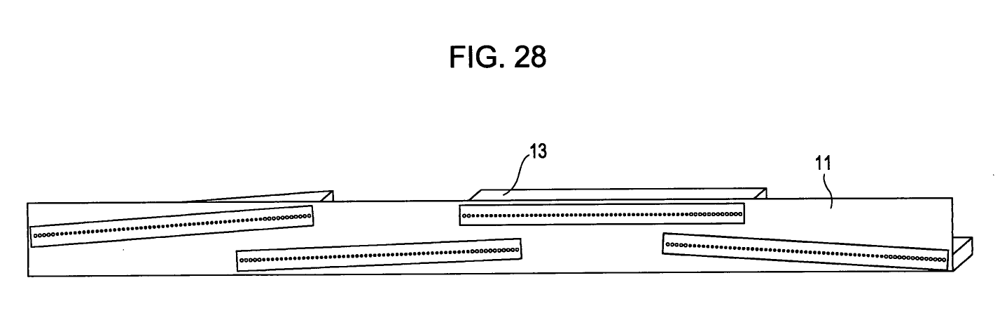

However, in actual cases such as the one shown in FIG. 28, the small heads 13 may be mounted with tilts with respect to the longitudinal direction of the large head 11. Although the small heads 13 shown in FIG. 28 are illustrated with noticeable tilts, the actual difference in level between the left end and the right end of each small head 13 is about tens of microns to a hundred and tens of microns at the maximum.

When the small heads 13 are tilted with respect to the longitudinal direction of the large head 11 as shown in FIG. 28, patterns formed therewith are not aligned on a straight line perpendicular to the sub-scanning direction even if print-data read addresses and print timings are slightly staggered in accordance with the amounts of errors in mounting positions.

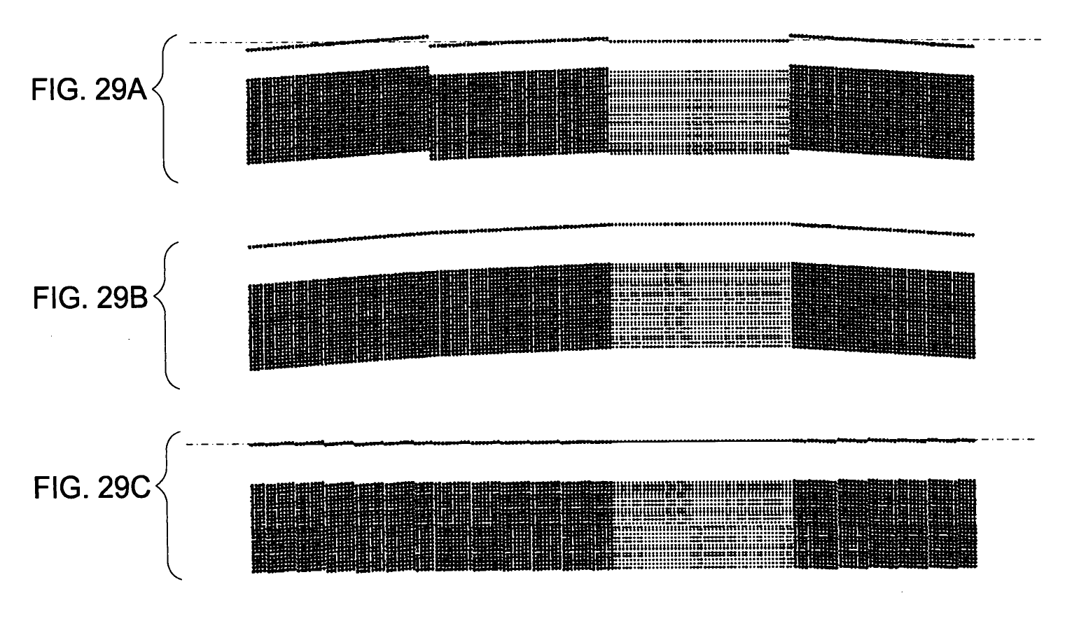

Referring to FIG. 29A, when the small heads 13 are aligned such that a pattern to be formed by one small head 13 positioned near the center of the large head 11 becomes perpendicular to the sub-scanning direction, steps are formed between that pattern and the patterns adjacent thereto.

In view of the above, the present inventor proposes a correction method in which, referring to FIG. 29B, steps between patterns formed by the central small head 13 and the small heads 13 adjacent thereto are minimized whether or not the line of patterns becomes perpendicular to the sub-scanning direction.

In this case, strictly speaking, it is difficult to print a straight line perpendicular to the sub-scanning direction. Instead, it becomes possible to form patterns aligned in a substantially straight line without irregularities at portions corresponding to boundaries between the small heads 13. Therefore, there is almost no problem in practical use.

To print an image with a particularly high positional accuracy, referring to FIG. 29C, each of the small heads 13 is divided into a plurality of sections and the print-data read address and the print timing are optimized for each of the sections. In this manner, a substantially straight line perpendicular to the sub-scanning direction can be formed.

Next, an adjustment method suitable for ink jet heads for multicolor printing including a plurality of large heads each having small heads mounted thereon with tilts will be described.

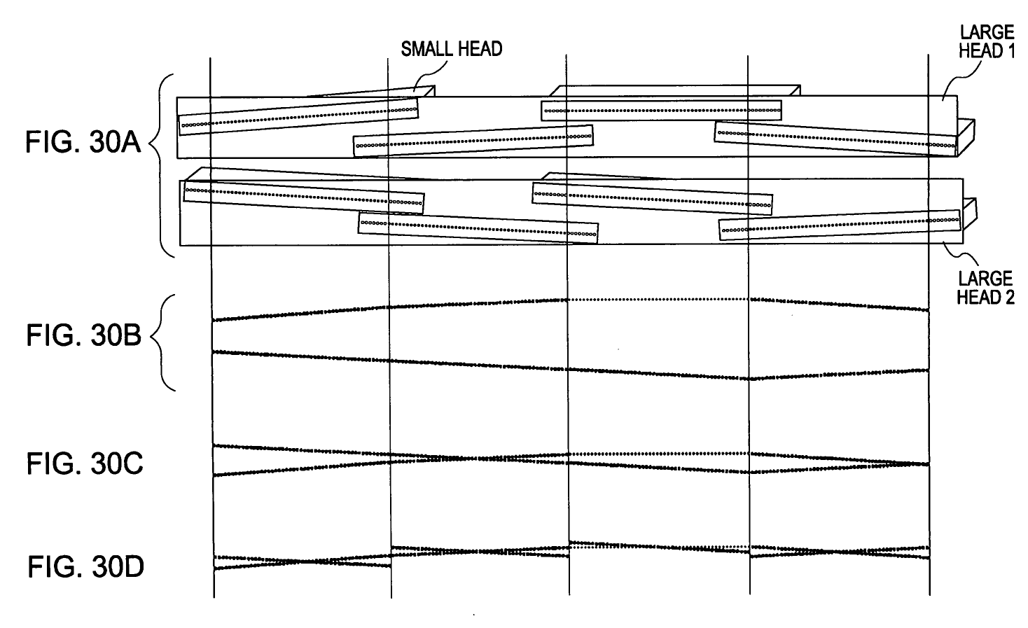

FIG. 30A shows an ink jet head including large heads 1 and 2. Needless to say, three or more large heads may be included.

Referring to FIG. 30B, suppose that print-data read addresses and print timings are adjusted such that steps at portions corresponding to boundaries between adjacent small heads are minimized independently for each of the large heads 1 and 2. In such a case, referring to FIG. 30C, shifts between patterns in different colors may become large, although steps between patterns formed by the small heads in the same color are eliminated.

In view of the above, the present inventor proposes the following method: The large head for printing in a certain color is defined as a reference large head. For the reference large head, print-data read addresses and print timings are adjusted such that steps between patterns formed by adjacent small heads are minimized. For the large head for printing in the other color, the amounts of adjustment are set such that steps between patterns respectively formed by small heads mounted on the reference large head and small heads mounted on the other large head are minimized.

FIG. 30D shows patterns when it is attempted printing a straight line by the method proposed by the present inventor. Compared to the one shown in FIG. 30C, color shifts are significantly reduced. In this method, although there still remain small steps between patterns formed by adjacent small heads, color shifts can be minimized.

Specifically, the large head for printing in black, which is used frequently particularly in printing ruled lines of diagrams and tables even in color printing, is subjected to correction for reducing steps, and the large heads for printing in the other colors are subjected to correction for reducing color shifts. In this manner, a printed matter having only negligible steps and small color shifts can be obtained.

### (A-4) Adjustment of Number of Orifices to be Used for Printing in Each Small Head

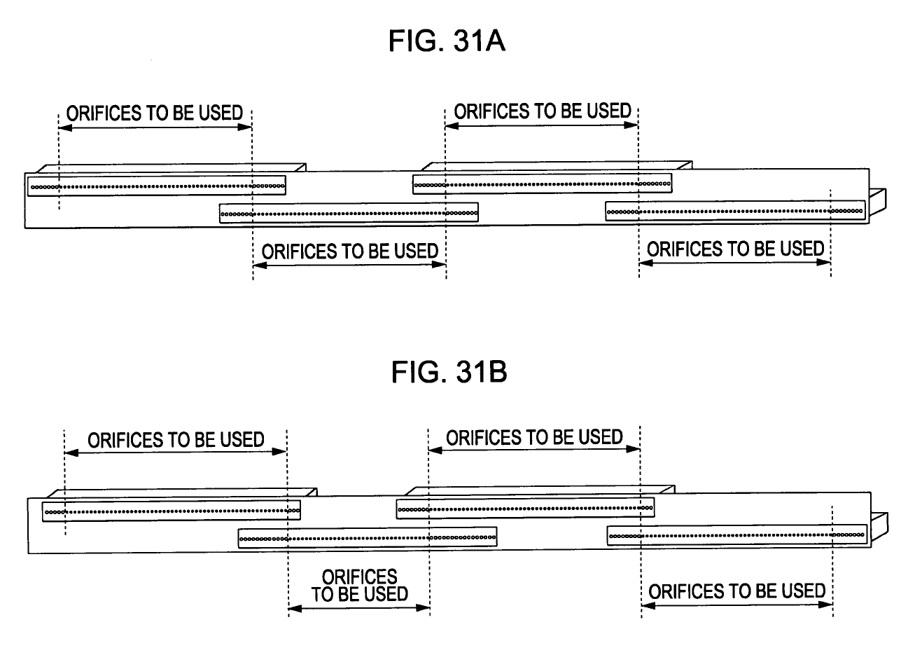

In the adjustment methods described above, it is assumed that, as shown in FIG. 31A, the same number of orifices are used for image printing in all the small heads.

Instead, as shown in FIG. 31B, different numbers of orifices may be used for printing in different small heads.

In particular, when the distance between adjacent small heads is too large or too small because of significant mounting errors, limiting the number of orifices to be used in a single small head leads to a significant limitation of the correctable shift. Therefore, it is advantageous not to limit the number of orifices to be used for printing.

Moreover, in color printing, if boundaries between small heads are set at the same positions for all the large heads for printing in their respective colors, as shown in FIG. 27, irregularities at boundaries that are negligible in an image of a single color may become noticeable when images of all the colors are combined together.

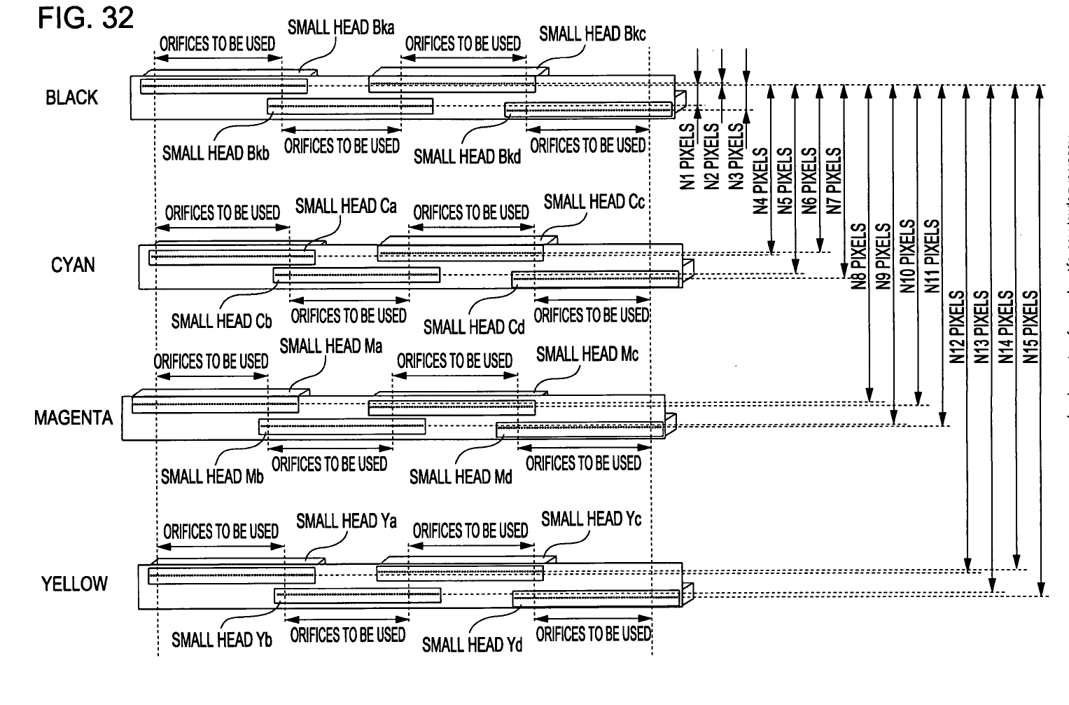

In view of the above, referring to FIG. 32, positions of boundaries between printable ranges of small heads (printable range switching positions) are made to be variable between different large heads for printing in their respective colors. Thus, irregularities at portions corresponding to boundaries can be further suppressed.

If maintenance of the orifices determined as not to be used for printing is neglected in the above case where only some of the orifices provided in each small head are used for printing, ink may be dried around such orifices and the dried ink may adversely affect ejection operation using the orifices at and around boundaries between small heads. To prevent this, the present inventor proposes a method in which maintenance operations such as air ejection and so forth are performed for all the orifices provided in the small heads whether the orifices are to be used or not to be used for printing.

### (A-5) Method for Printing at Boundaries

The foregoing description concerns the case where a single pattern to be formed exactly corresponds to a single small head.

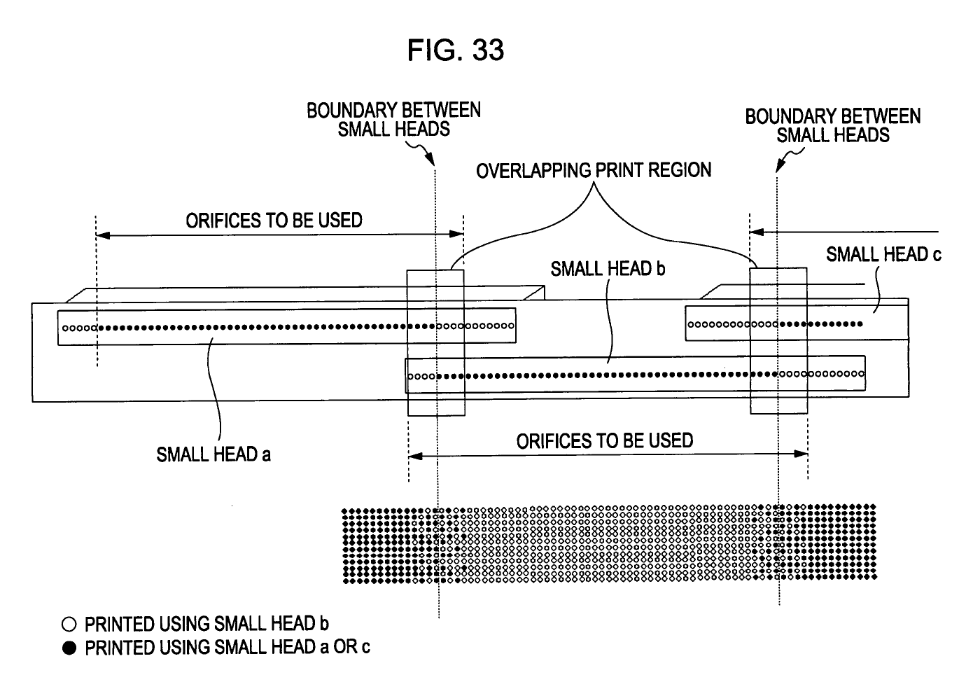

In this method, referring to FIG. 33, the range of orifices to be used for printing provided in one small head may overlap at ends thereof with the ranges of orifices to be used for printing provided in small heads adjacent thereto.

In this case, a region of several pixels centered at each position corresponding to the boundary between two small heads is printed using the two small heads. Further, with respect to the boundary, the proportion of orifices to be used for printing in that region among all the orifices in one of the two small heads is reduced, while the proportion of orifices to be used among all the orifices in the other small head is increased.

By incorporating, with the above method, density correction for suppressing irregularities at portions corresponding to boundaries between small heads, the irregularities at such portions can be further suppressed.

Also in this case, by combining various methods including individual setting of the range of orifices to be used for printing, control of the print timing, and density correction, a print result of good quality can be obtained even if errors in mounting positions of small heads are larger than those in the related-art ink jet heads.

### (A-6) Ink Jet Head Capable of Deflected Ejection

In printing apparatuses including ink jet line heads and printing apparatuses including ink jet serial heads, in which an area of a predetermined width is printed with a single pass, variations in the direction of ejection among orifices are observed in the printing direction.

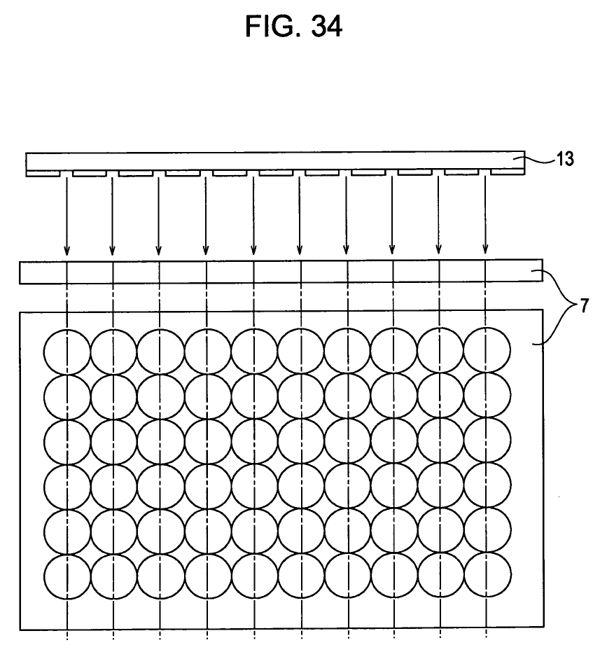

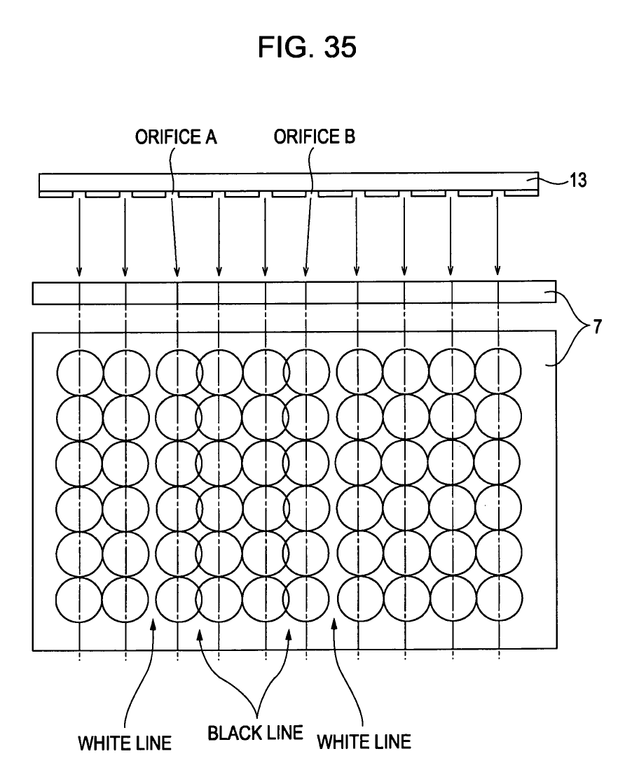

Therefore, although it is desired that pixels be aligned as shown in FIG. 34 in the direction of ejection from orifices, the actual printed matter may undesirably have line-type irregularities as shown in FIG. 35.

To solve this, the present inventor and applicant propose a printing method in which the angle of ejection is deflected during printing.

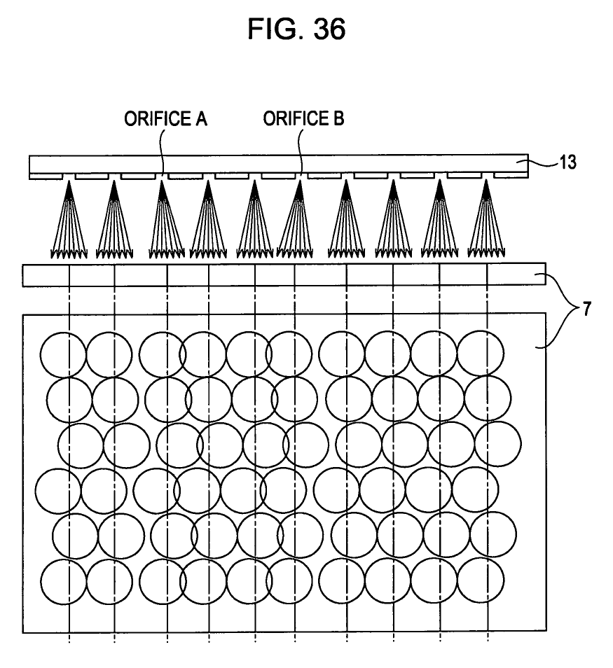

FIG. 36 shows an exemplary case where this method is put into practice by varying the direction of ejection for each orifice and for every ejection, within the range of the corresponding pixel row. In this case, even if the directions of ejection from some of the orifices, such as orifices A and B, are slightly slanted, line-type irregularities can be suppressed to a negligible level.

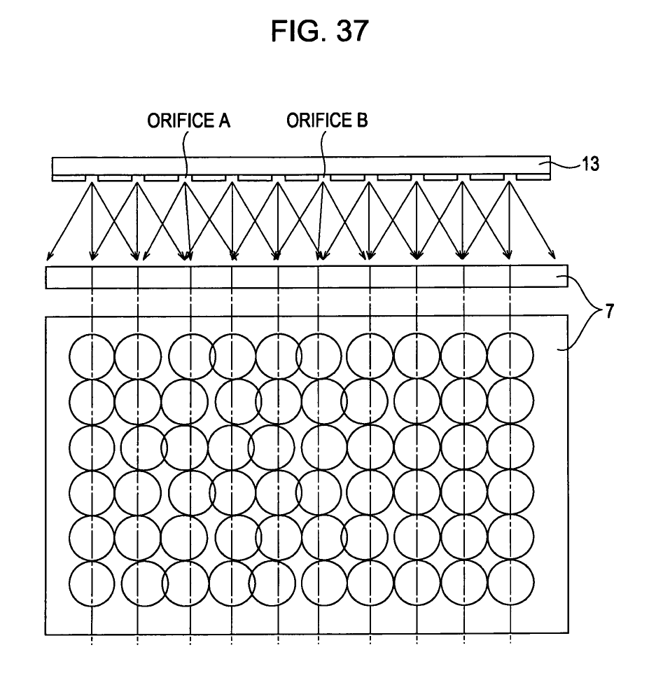

FIG. 37 shows another exemplary case where each orifice is set to be available for printing of a range of several pixels laterally adjacent to each other so that a single pixel row can be printed by using different orifices. In this case, even if the directions of ejection from some of the orifices, such as orifices A and B, are slightly slanted, line-type irregularities can be suppressed to a negligible level. Moreover, even if there are variations in the volume of ejection among different orifices, such variations are evened out and therefore variations in density can also be suppressed to a negligible level.

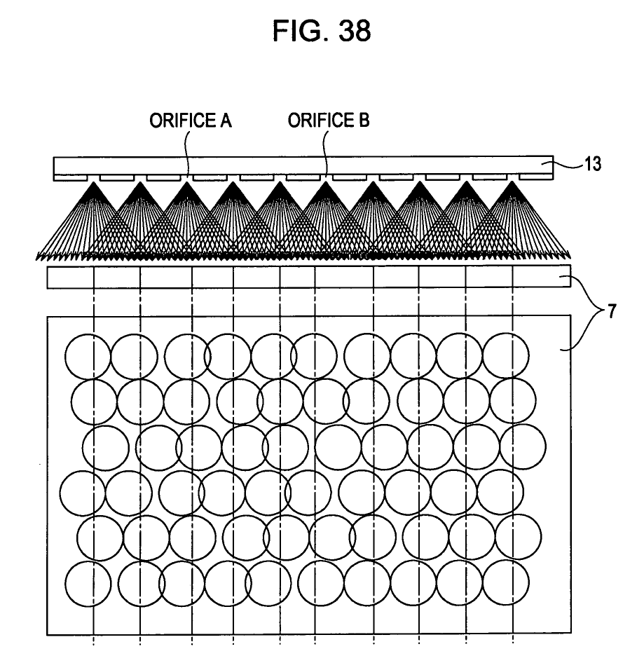

FIG. 38 shows another exemplary case where each orifice is set to be available for printing of a range of several pixels laterally adjacent to each other so that a single pixel row can be printed by using different orifices while the direction of ejection is varied for each orifice within the range of the corresponding pixel row. In this case, even if the directions of ejection from some of the orifices, such as an orifice A, are slightly slanted, much finer correction can be realized, whereby line-type irregularities can be further suppressed.

Moreover, in this method, even if there are variations in the volume of ink to be ejected among different orifices, variations in the volume of ink to be used for forming a single pixel row are evened out and therefore variations in density can also be suppressed to a negligible level.

By solely applying this method to adjustment at portions corresponding to boundaries between small heads, line-type irregularities occurring at such portions can be reduced.

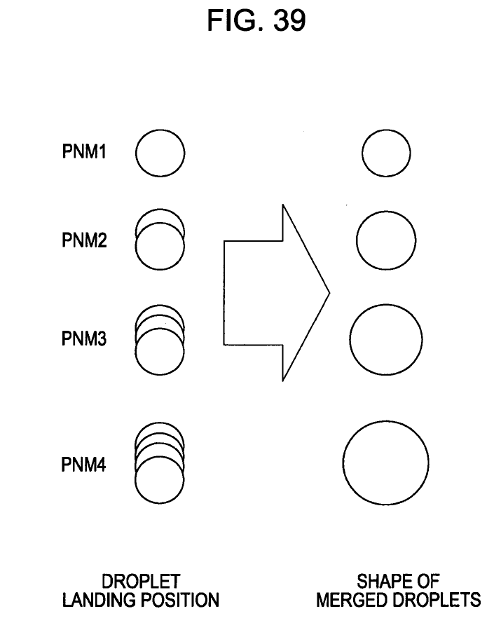

Here, a pulse number modulation (PNM) method is employed in which the size of dots to be formed is changed by changing the number of droplets to be ejected for forming a single pixel. FIG. 39 shows the concept of the PNM method.

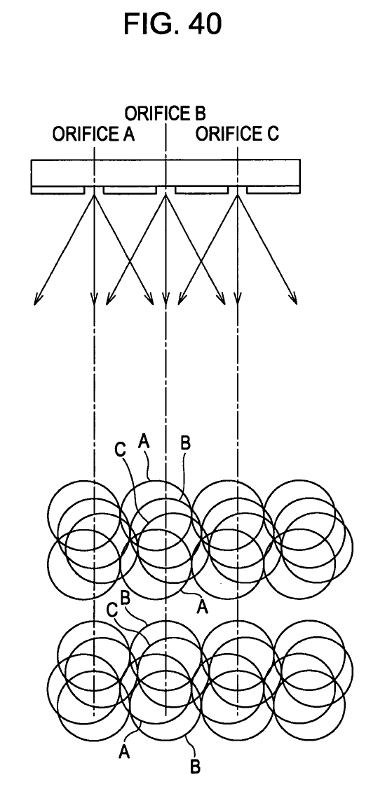

FIG. 40 shows the concept of a method in which the maximum PNM value is set to 4 and ink droplets are ejected sequentially from three different orifices.

In FIG. 40, when a first pixel is printed with a first timing, an orifice A is used.

When the first pixel is printed with a second timing, an orifice B is used. When the first pixel is printed with a third timing, an orifice C is used.

When the first pixel is printed with a fourth timing, the orifice A is used.

When a second pixel is printed with the first timing, the orifice B is used. When the second pixel is printed with the second timing, the orifice C is used. When the second pixel is printed with the third timing, the orifice A is used. When the second pixel is printed with the fourth timing, the orifice B is used.

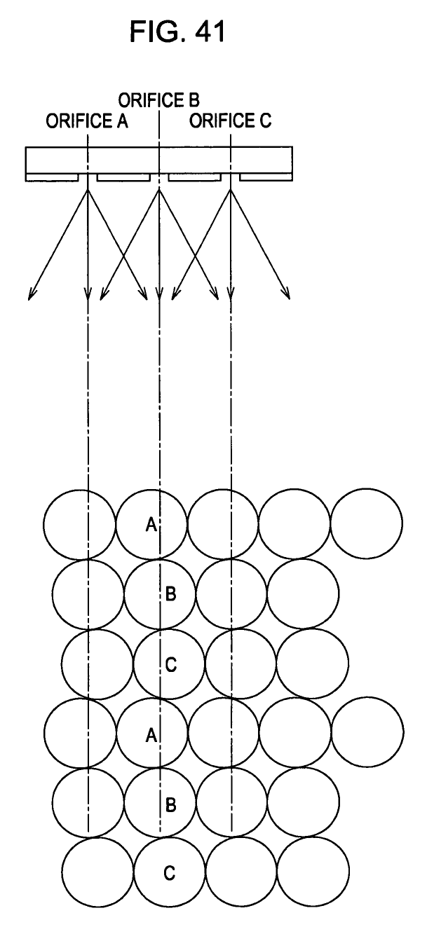

For example, according to the PNM printing method, if a single pixel is printed by ejection of a single ink droplet only with the first timing, the relationship between landed ink droplets and the orifices becomes as shown in FIG. 41.

Specifically, the first pixel is printed using the orifice A, the second pixel is printed using the orifice B, the third pixel is printed using the orifice C, the fourth pixel is printed using the orifice A, and this further goes on. That is, the output source of ink droplets in a single pixel row changes sequentially.

Now, two exemplary adjustment methods will be described in which irregularities at portions corresponding to boundaries between small heads are suppressed to a negligible level by employing the deflected ejection described above.

### (a) Method for Printing at Boundaries Using One of Two Small Heads

If small heads capable of deflected ejection are used, a single pixel row can be printed with ink droplets ejected from a plurality of orifices provided in a single small head.

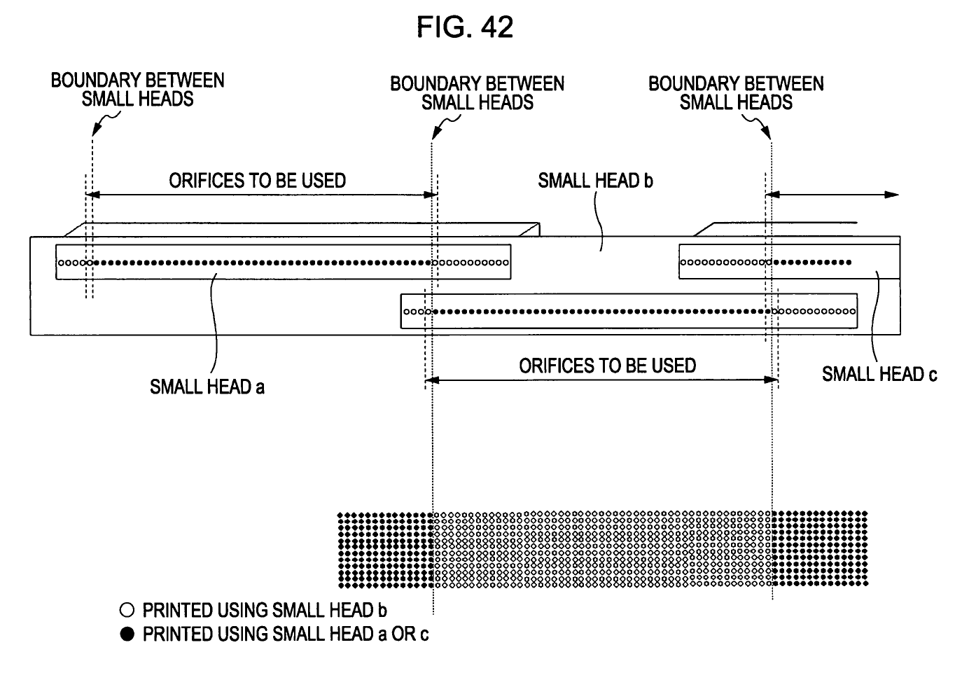

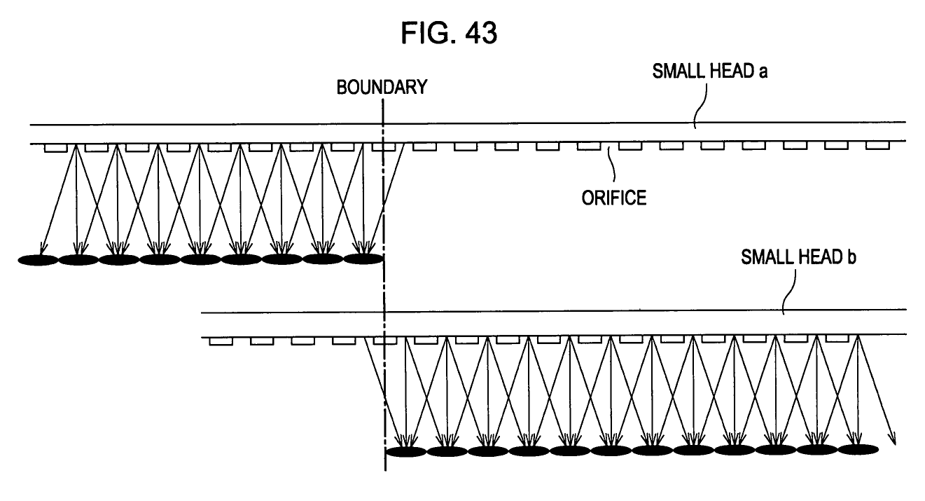

FIGS. 42 and 43 each show the concept of this printing method. As shown in FIGS. 42 and 43, in each region between positions corresponding to boundaries of the small heads, where the small heads are switched between, pixel rows are printed by only using orifices responsible for printing provided in the corresponding small head.

Therefore, the range of orifices specified to be used in the individual small heads extends beyond the small-head-switching positions.

For example, FIG. 43 shows that, for each small head, the orifice immediately outside the boundary deflectively ejects ink droplets for printing the pixel row immediately inside the boundary.

By employing such a deflected ejection method, a single pixel row can be printed by using a plurality of orifices. Therefore, even if there are small irregularities, including gaps and overlaps, at small-head-switching positions, such line-type irregularities can be suppressed to a negligible level.

### (b) Method for Printing at Boundaries Using Two Small Heads

If small heads capable of deflected ejection are used, a single pixel row can be printed with ink droplets ejected from a plurality of orifices provided in different small heads.

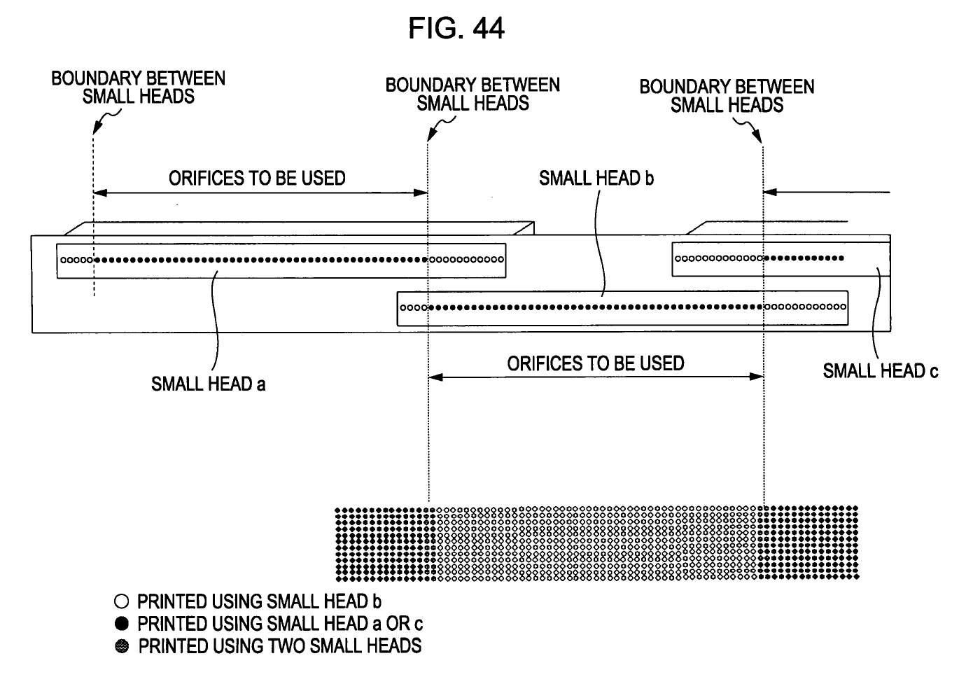

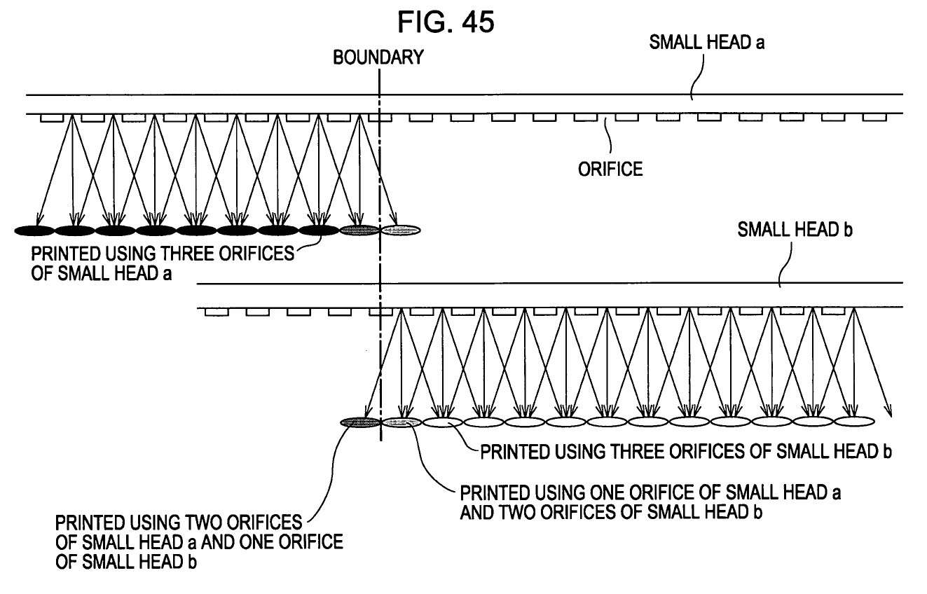

FIGS. 44 and 45 each show the concept of this printing method.

As shown in FIGS. 44 and 45, the small heads each eject ink droplets deflectively beyond the boundaries therebetween. In this manner, adjacent pixel rows with the boundary defined therebetween are each printed with ink droplets ejected from different small heads.

In this case, the range of orifices to be used specified for the individual small heads coincides with a region defined by adjacent small-head-switching positions.

By employing such a deflected ejection method, a single pixel row can be printed by using a plurality of orifices. Therefore, even if there are small irregularities, including gaps and overlaps, at small-head-switching positions, such irregularities can be suppressed to a negligible level. Moreover, even if there are variations in density among small heads, such variations can be reduced.

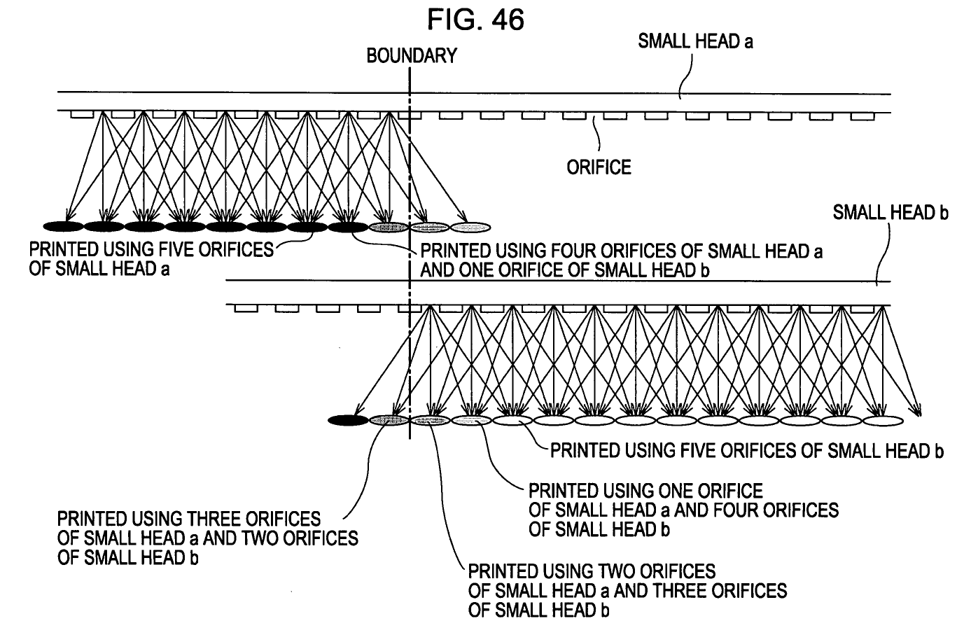

Additionally, two or more pixel rows immediately outside the boundary may be printed by using different small heads. FIG. 46 shows a case where two pixel rows immediately outside the boundary are printed by using different small heads. In FIG. 46, a single orifice can deflectively eject ink droplets in five different directions.

As can be seen from FIGS. 45 and 46, if the proportions of ink droplets provided from different orifices to the individual pixel rows are the same, the proportion of orifices to be used in one of two adjacent small heads relative to the proportion of orifices to be used in the other small head in a region around the small-head-switching position gradually changes from that of the one small head to that of the other, and vice versa. Therefore, irregularities at the small-head-switching positions are suppressed to a negligible level.

The method for gradually changing the proportion of orifices of the one small head to be used for printing pixel rows to that of the other small head, and vice versa, is the same as the method described above referring to FIG. 33. However, in the method shown in FIG. 33, a certain number of orifices are to be reserved for printing the aforementioned region using a plurality of small heads. This leads to a reduction in the number of orifices available for correction of positional errors between small heads.

In the methods shown in FIGS. 45 and 46, the proportions of orifices to be used can be gradually changed between adjacent small heads without reducing the number of orifices available for correction of the positional errors.

In addition, such a deflected ejection function suppresses fine line-type irregularities caused by variations in ejection performance of orifices not only at portions corresponding to boundaries but also in other regions. Therefore, it is desirable to apply the deflected ejection function to printing of all the pixels. Needless to say, the deflected ejection function may be applied only to printing at boundaries.

### (A-7) Other Configurations of Small Head

The foregoing description concerns the case where each small head is dedicated for ejection of ink droplets of a single color.

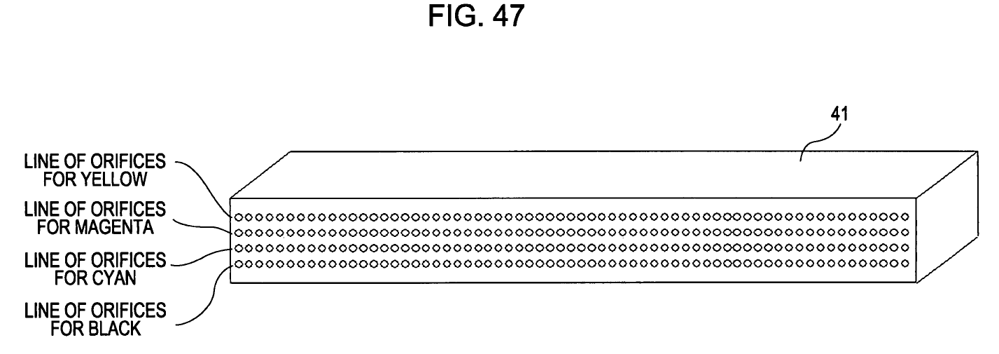

Alternatively, referring to FIG. 47, a single small head may be provided with a plurality of lines of orifices so that ink droplets of a plurality of colors can be ejected therefrom.

A small head 41 for printing in multicolor has four lines of orifices: a line of orifices for printing in yellow, a line of orifices for printing in magenta, a line of orifices for printing in cyan, and a line of orifices for printing in black.

Needless to say, a plurality of the small heads 41 may be provided in a large head, to which the above-described techniques may be applied.

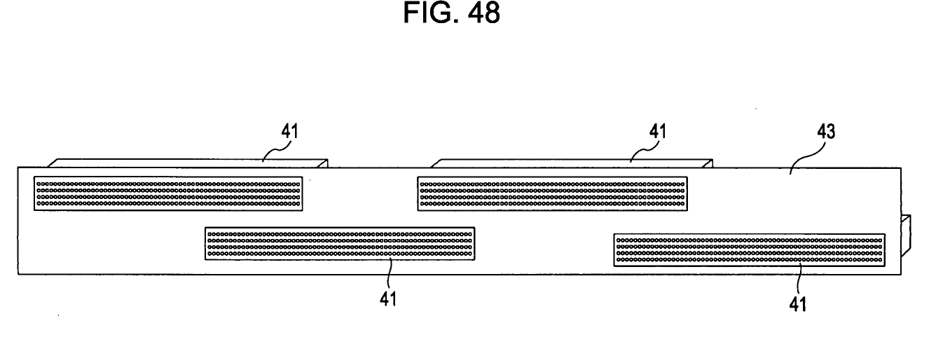

FIG. 48 is an external view showing an exemplary configuration of a large head 43 in which the small heads 41 are disposed adjacent to one another along the direction of the lines of orifices at staggered positions such that ranges of orifices to be used for printing in the respective small heads 41 partially overlap one another.

Also in the large head 43, gaps, overlaps, and steps at portions corresponding to boundaries between the small heads 41 can be reduced by adjusting the ranges of orifices to be used and information on print-data addresses and ejection timings supplied to the small heads 41. Further, with density correction, printing can be performed with negligible irregularities at portions corresponding to boundaries between the small heads 41.

### (B) Advantages Produced by the Adjustment Methods

As described above, even if small heads are mounted on a large head with some positional errors therebetween, positional shifts between patterns formed on a target recording medium can be minimized by adjusting print-data read addresses and print timings.

If density correction and deflected ejection are incorporated with any of the foregoing adjustment methods, irregularities at portions corresponding to boundaries between small heads can be further reduced.

Consequently, a large head capable of producing a high-quality print result only with negligible irregularities at portions corresponding to boundaries between small heads can be realized with a low cost.

### (C) Examples of Printing System

Now, several examples of a printing system to which the above-described methods can be applied will be described.

### (a) System Example 1

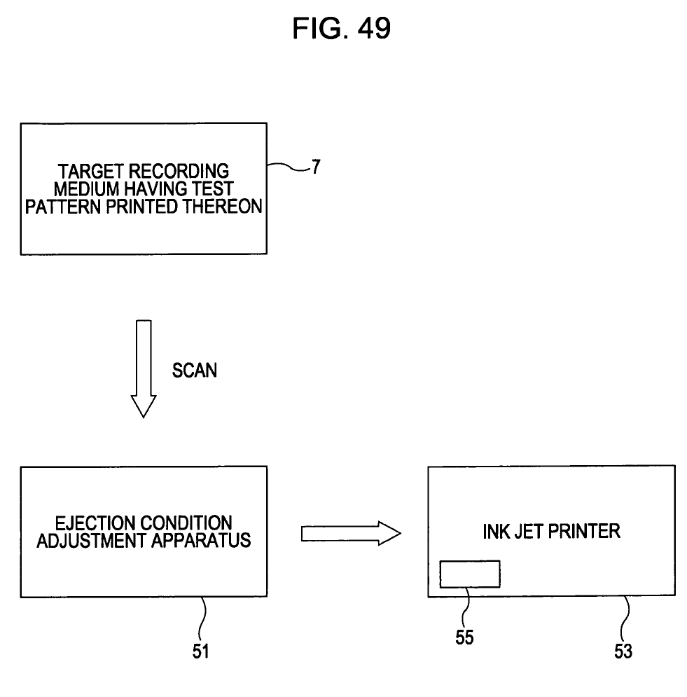

FIG. 49 shows an exemplary printing system that includes an ejection condition adjustment apparatus 51 and an ink jet printer 53 as separate bodies.

In this example, the ejection condition adjustment apparatus 51 reads scanned data on a target recording medium 7 having a test pattern printed thereon (i.e., data on landing positions of ink droplets ejected from orifices), takes actual measurements, such as positional shifts and tilts with respect to the direction of lines of orifices provided in the small heads; steps at portions corresponding to boundaries between the small heads; and the like, and supplies the measurements to the ink jet printer 53 in a form of adjustment values for adjusting print-data read addresses and print timings.

The ink jet printer 53 has a memory (ejection condition memory) 55 that stores the adjustment values for adjusting ejection conditions. Print-data read addresses and print timings are adjusted in accordance with these adjustment values.

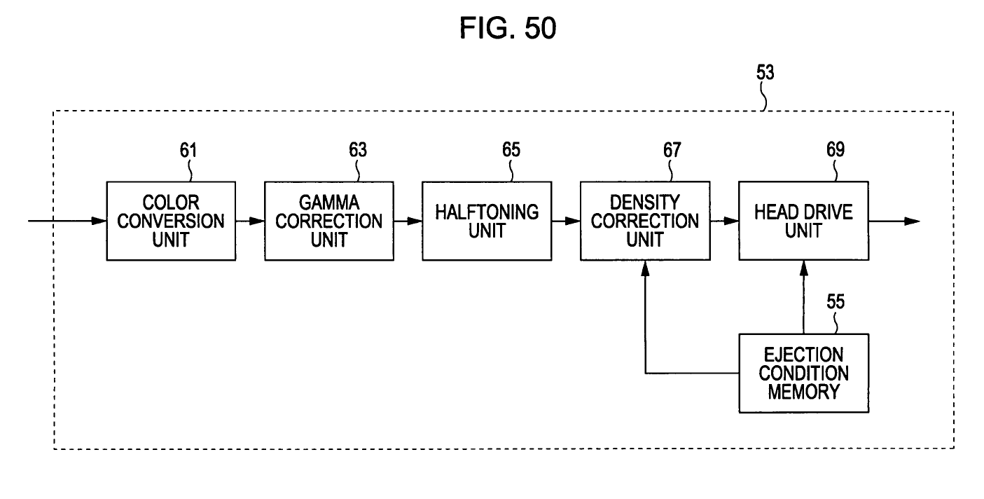

FIG. 50 shows an internal configuration of the ink jet printer 53.

In FIG. 50, the ink jet printer 53 includes a color conversion unit 61, a gamma correction unit 63, a halftoning unit 65, a density correction unit 67, a head drive unit 69, and an ejection condition memory 55. These units have known processing functions. The processing functions will be briefly described below.

The color conversion unit 61 is a processing unit that converts data on the original colors into data on corresponding complementary colors (yellow (Y), magenta (M), cyan (C), and black (K)).

The gamma correction unit 63 is a processing unit that converts the data on complementary colors into data such that the density of ink droplets is expressed in conformity with tone values of the data on complementary colors.

The halftoning unit 65 is a processing unit that converts the data on complementary colors into data expressed in the number of ink droplets.

The density correction unit 67 is a processing unit that corrects densities to be reproduced on the target recording medium 7. In this example, the density correction unit 67 performs density correction in accordance with the adjustment conditions stored in the ejection condition memory 55.

The head drive unit 69 is a processing unit that drives an ink jet head (not shown, a large head on which a plurality of small heads are disposed at staggered positions). It should be noted that print-data read addresses and print timings are corrected in accordance with the adjustment conditions stored in the ejection condition memory 55.

With such an internal configuration, various adjustment methods proposed by the present inventor can be realized. In addition, density correction may be performed during gamma correction.

### (b) System Example 2

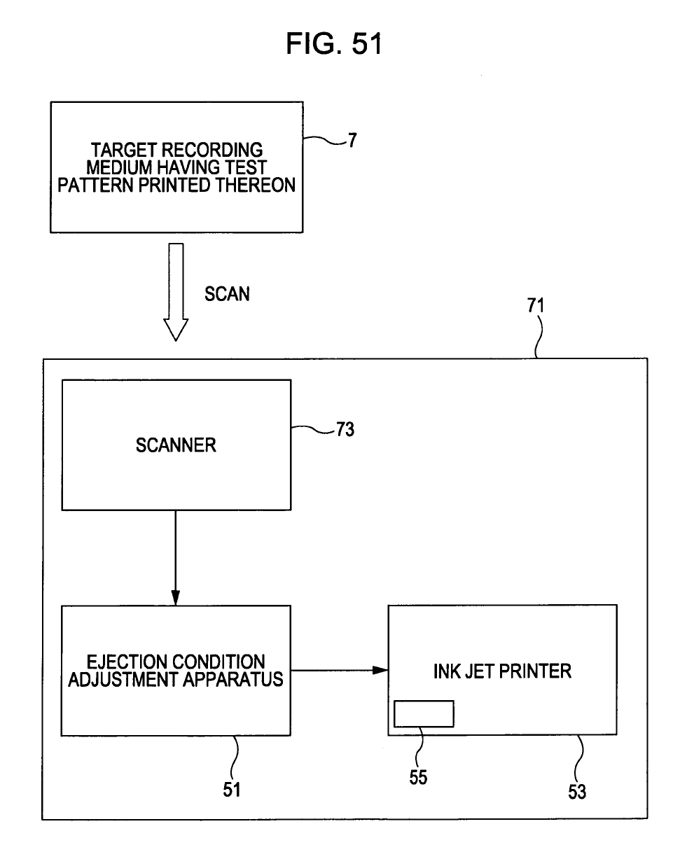

FIG. 51 shows an example of a multifunctional printing system that includes the ejection condition adjustment apparatus 51 and the ink jet printer 53 in an integral body.

In FIG. 51, a multifunction system 71 includes a scanner 73, in addition to a printing function. That is, the multifunction system 71 includes the scanner 73, the ejection condition adjustment apparatus 51, and the ink jet printer 53.

In this example, the multifunction system 71 reads a test pattern, which is printed by an ink jet head mounted thereon, by using the scanner 73 mounted thereon and automatically sets adjustment values.

Adjustment values may be supplied by a manufacturer or a provider over a network or the like in a case such as where adjustment values are originally written in a memory provided with an ink jet head.

### (D) Other Embodiments

### (D-1) Examples of Application to Other Apparatuses

The foregoing description concerns the case where the adjustment methods according to the embodiments of the present invention are applied to ink jet printers.

Alternatively, as long as the methods are applied to apparatuses that eject droplets from nozzles, the fields of application of the methods are not limited. For example, the methods can be applied to apparatuses that eject, in a form of droplets, liquids containing organic materials, inorganic materials, or metal materials.

### (D-2) Modifications

Various modifications can be made to the above-described embodiments within the scope of the present invention. Further, other various modifications and applications can be provided in accordance with or as combinations of the descriptions specified herein.

What is claimed is:

1. An ejection condition adjustment apparatus, comprising:
a unit configured to set, in a case where a large head to be driven includes a plurality of small heads each having a number of orifices and the small heads are disposed adjacent to one another on the large head such that regions of the respective small heads where the orifices are provided partially overlap one another,
a range of orifices to be used and an ejection timing for the individual small heads such that positional shifts between adjoining ones of patterns formed by the respective small heads are minimized.

2. The ejection condition adjustment apparatus according to claim 1, wherein a pattern-data read address and the ejection timing are set for the individual small heads such that occurrence of positional shifts between adjoining ones of patterns formed by the respective small heads is prevented.

3. The ejection condition adjustment apparatus according to claim 1, wherein a density correction value is set for the individual small heads such that occurrence of variations in density between adjoining ones of patterns formed by the respective small heads is prevented.

4. The ejection condition adjustment apparatus according to claim 1,
wherein, in a case where liquids of a plurality of kinds are ejectable by using a single large head or a plurality of large heads,
the range of orifices to be used and the ejection timing are set for the individual small heads belonging to a group associated with a liquid of one of the kinds, such that positional shifts between adjoining ones of patterns formed by the respective small heads are minimized, while
the range of orifices to be used and the ejection timing are set for the individual small heads belonging to each of groups respectively associated with liquids of the other kinds, such that positional shifts of patterns formed by the small heads belonging to each of the groups associated with the liquids of the other kinds from the patterns formed by the small heads belonging to the group associated with the liquid of the one kind are reduced.

5. The ejection condition adjustment apparatus according to claim 1,
wherein, in a case where liquids of a plurality of kinds are ejectable by using a single large head or a plurality of large heads,
the range of orifices to be used for forming patterns and the ejection timing are set for the individual small heads belonging to each of groups corresponding to liquids of the respective kinds, such that positions of boundaries between the patterns formed by the small heads adjacent to one another differ among the groups of the small heads.

6. The ejection condition adjustment apparatus according to claim 4, wherein the liquids of the plurality of kinds include liquids of the same ingredient but different densities.

7. The ejection condition adjustment apparatus according to claim 1, wherein the same maintenance operation is performed on all the orifices provided in the small heads, including the orifices other than the orifices to be used.

8. The ejection condition adjustment apparatus according to claim 1, wherein the small heads are capable of deflected ejection.

9. A droplet ejecting apparatus comprising:
a large head including a plurality of small heads each having a number of orifices;
an ejection condition storing unit configured to store, in a case where the small heads are disposed adjacent to one another on the large head such that regions of the respective small heads where the orifices are provided partially overlap one another, information on a range of orifices to be used and an ejection timing that are set for the individual small heads such that positional shifts between adjoining ones of patterns formed by the respective small heads are minimized; and
a head driving unit configured to cause the large head to perform ejection of liquid in accordance with the information on the range of orifices to be used and the ejection timing.

10. An ejection condition adjustment method in a case where a large head to be driven includes a plurality of small heads each having a number of orifices, the method comprising the steps of:
disposing the small heads adjacent to one another on the large head such that regions of the respective small heads where the orifices are provided partially overlap one another; and
setting a range of orifices to be used and an ejection timing for the individual small heads such that positional shifts between adjoining ones of patterns formed by the respective small heads are minimized.

11. An ejection condition adjustment method in a case where a large head to be driven includes a plurality of small heads each having a number of orifices, the method comprising the steps of:
disposing the small heads adjacent to one another on the large head such that regions of the respective small heads where the orifices are provided partially overlap one another; and
performing ejection of liquid droplets in accordance with a range of orifices to be used and an ejection timing that are set such that positional shifts between adjoining ones of patterns formed by the respective small heads are minimized.

12. A program causing a computer, in a case where a large head to be driven includes a plurality of small heads each having a number of orifices and the small heads are disposed adjacent to one another on the large head such that regions of the respective small heads where the orifices are provided partially overlap one another, to execute a method comprising the step of:
setting a range of orifices to be used and an ejection timing for the individual small heads such that positional shifts between adjoining ones of patterns formed by the respective small heads are minimized.

13. A program causing a computer, in a case where a large head to be driven includes a plurality of small heads each having a number of orifices and the small heads are disposed adjacent to one another on the large head such that regions of the respective small heads where the orifices are provided partially overlap one another, to execute a method comprising the step of:
performing ejection of liquid droplets in accordance with a range of orifices to be used and an ejection timing that are set such that positional shifts between adjoining ones of patterns formed by the respective small heads are minimized.
